(19) United States
(12) Patent Application Publication
(10) Pub. No.: US 2009/0290555 A1
(43) Pub. Date: Nov. 26, 2009

(54) Autonomous anonymous association between a mobile station and multiple network elements in a wireless communication system

(75) Inventors: Yaron Alpert, Hod Hasharon (IL); Jonathan Segev, Tel Mond (IL); Erez Ben-Tovim, Ra'anana (IL)

Correspondence Address: Zaretsky Patent Group PC, 20783 N 83rd Ave, Ste 103-174, Peoria, AZ, 85382-7430, US

(73) Assignee: Comsys Communication & Signal Processing Ltd.

(21) Appl. No.: 12/124,406

(22) Filed: May 21, 2008

(51) Int. Cl. H04Q 7/00

(52) U.S. Cl. 370/331

(57) ABSTRACT

A novel and useful autonomous association mechanism for use in user equipment (UE) network connections in one or more cellular communications systems. The handover process is optimized by improving the selection of target base stations and optimizing the discontinuity period from the time of disconnection from a serving base station and connection to a target base station and by establishing anonymous bidirectional communications with base stations. The mechanism facilitates multiple cell association in a network unaware manner while preserving single endpoint connectivity. The UE does not need to negotiate for or receive pre-allocated opportunities from the network for making associations with neighboring base stations. Association opportunities are created by the UE autonomously in accordance with UE activity patterns. Association opportunities are used to exchange preliminary information needed for handover between the UE and candidate base stations over the same or a plurality of access technologies. The information includes any parameter that can affect the handover process, e.g., link quality, etc.

### REFERENCE TO RELATED APPLICATION

This application is related to U.S. application Ser. No. 12/124,391, filed May 21, 2008, entitled “Autonomous connectivity between a mobile station and multiple network elements for minimizing service discontinuities during handovers in a wireless communication system,” incorporated herein by reference in its entirety.

### FIELD OF THE INVENTION

The present invention relates generally to wireless communication systems and more particularly relates to an apparatus for and method of autonomous and/or anonymous association between a mobile station and multiple network elements in a wireless communication system.

### BACKGROUND OF THE INVENTION

Cellular networks, well known in the art, are in widespread use around the world. A cellular network is a radio network made up of a number of cells wherein each cell is served by a base station (i.e. cell site). Cells are used to cover geographic areas to provide radio coverage over a wider area than the area of any one cell. Radio transceivers in each cell communicate with multiple mobile stations within its coverage region.

A diagram illustrating an example prior art cellular network is shown in FIG. 1. The network, generally referenced 10, comprises a network cloud 18 having a plurality of base stations and mobile stations (MSs). A mobile station 16 is normally connected to a serving base station (BS) 12 or serving cell via wireless link connection 13. The mobile unit or mobile station (MS) 16 is synchronized and registered into the network using wireless link connection 13 to the base station 12. Depending on its location, the mobile station may receive signals from not only serving base station 12 but also from other base stations that are considered candidate base stations or candidate cells 14 via “links” (as indicated by dashed arrow 15).

In cellular and other wireless communication systems, one or more mobile stations may establish a wireless link to a Radio Access Network (RAN). Call state information associated with each mobile station call session is stored in the network, where it is feasible to use a central repository such as a Radio Network Controller (RNC), a Packet Data Serving Node (PDSN), etc. or to use a distributed network architecture (e.g., WiMAX BS and ASN gateways).

In a cellular network, the handoff or handover process refers to the process of transferring an ongoing call or data session from one RAN channel (connection/link) to another. The details of the handoff process differ depending on the type of wireless link connection, network and the factors causing a need for the handoff. For example, one of the handoff restrictions is typically not to interrupt ongoing communications between the mobile station and the base station or to set this un-connectivity time to minimal. In this case, there must be clear coordination between the base station and the mobile station. As the mobile station moves from one cell area to another, the base station commands the mobile station to tune to a new radio channel or allocation that is considered as more suitable for maintaining the connection. When the mobile station responds through the new cell site, the network switches the connection to the new cell site accordingly.

The predicted handoff process, in case the MS does not lose connectivity within the network, is a network managed process that proceeds in a master/slave manner. In this case, the network allocates bandwidth for control and signaling. In the prior art managed handoff process, the network may instructs the user equipment (i.e. MS) to execute measurements and to report results of these measurements to the network. Based on these results or other network considerations, the network makes the handoff decision. A disadvantage of this type of handoff process, however, is that it consumes resources and reduces capacity due to need for the interaction of messages between the network and the user equipment and the additional delay occurs due to the MS measurements and reporting time. In addition, the handoff decision may be suboptimal due to the allocation pattern of measurements opportunity by the network and the reporting time delays.

In unpredicted handover, the MS maintains connectivity with the network but performs a handover to a target base station without notification or permission from the serving base station, rather than using a network managed process that normally takes place in a master/slave arrangement in a predicted handover. An unpredicted handover, however, has advantages over predicted handover in that unpredicted handover does not consume resources and does not reduce network capacity since there is no interaction of messages between the network and user equipment. A disadvantage, however, is that TBS network entry time is extended so the service continuity may be impaired.

A handoff may occur for several reasons, examples of which include: (1) in case the MS moves away from an area covered by a serving first cell and enters an area covered by another second cell, the call is transferred to the second cell in order to avoid call termination; (2) when the capability for connecting new sessions or maintaining existing sessions within a given cell is exceeded and the sessions is transferred to another cell in order to free up capacity in the first cell; and (3) in some networks, when channel interference is caused by another MS using the same channel in a different cell, the call is transferred to a different channel in the same cell or to a different channel in another cell in order to avoid the interference.

Handoffs can be divided into hard and soft handoffs. In a hard handoff, the link level connectivity in the serving cell is first terminated, then the link level connectivity to a selected target cell is engaged. Such handoffs are thus referred to as a break-before-make process. Therefore, it is desirable to minimize the time to implement a hard handoff in order to minimize any disruption to the sessions. In many applications (such as real time applications) it is critical that any discontinuity in the handoff process be reduced to a minimum. Real time service applications such as video sessions or voice sessions are very sensitive to discontinuities during handoff as the results range from annoying delay to dropped sessions. Note that the discontinuity duration is related to the level of synchronization between the MS and the Target BS (TBS) and the underlying network handoff protocol.

In addition, it is desirable to maximize the probability of success of the handover process since failure to handoff to the Target BS (TBS) or reverting to the Source SB (SBS) results in sessions being dropped. The probability of success of the handoff process is typically affected by two factors: (1) the quality and timing of the handoff decision and (2) the synchronization of the MS receiver to the new assigned channel (or recourse) in the TBS.

In a soft handoff, the link level connectivity to the SBS is retained and used in parallel with the link level connectivity to the TBS for a short period of time. This process if fully control and coordinate by the network. Since the link level connectivity to the TBS is established before the link level connectivity to the SBS is broken, such handoffs are referred to as make-before-break. Note that a soft handoff may involve connections to more than two TBS. When a session is in a state of soft handoff, the best signal from among the available links is utilized for the session.

To execute a handoff each cell is assigned a list (i.e. the neighbor list) of potential target cells (TBSs), which can be used for handing off calls to. During MS connectivity of a certain cell, one or more parameters of the signal in the link in the source cell (SBS) are monitored by the BS, monitored by the MS and reported to the BS and assessed by the MS, BS or other network element in order to decide whether a handoff is necessary. The handoff may be requested by the MS, by the base station (BS) or other network element. The MS may monitor based on set of instruction send by the SBS signals of best target candidates selected among the neighboring cells.

The parameters used as criteria for requesting handoff may include (depending on the particular system): actual or estimates of the received signal power, received signal-to-noise ratio, bit error rate (BER) and block error/erasure rate (BLER), packet error rate (PER), burst error rate (BuER), received quality of sessions (i.e. speech quality, video quality level, etc.), SNR, RTD, interferences level, CQI, HARQ retransmission level/success ratio, distance between the MS and the BS estimated based on radio signal propagation delay, Ec/lo ratio measured of common or dedicated transmission elements.

A diagram illustrating a prior art handover preparation and execution flow is shown in FIG. 2. In the handover preparation stage 230, the target base station (TBS) HO parameters are received for the serving base station (SBS) (step 220). After getting an appropriate command from the SBS or based on a trigger the MS follows into HO execution phase. The HO execution phase starts when the mobile station (MS) synchronizes with the TBS (step 222) and decodes the downlink (DL) information received from the TBS (step 224). The MS then performs an association at the PHY level with the TBS (step 225).

The MS then performs an association at the MAC level (step 226). It is during this step that data is exchanged between the TBS and MS. The actual data exchanged depends on the particular radio technology. For example, training sequence, messages, notification signals, various preliminary information needed by the TBS to establish a bidirectional link to the MS, information exchange, identification and capability negotiation, authorization, authentication, and other well-known MAC association tasks. In order to remain anonymous, however, the MAC association is halted before the identification stage. Once association at the MAC level is complete, the network then re-connects to the new TBS (step 228) and resumes the active sessions.

In prior art mobile communication systems, MS connectivity and association is fully controlled and coordinated by the network using the air link interface to the serving base station. Decisions as to which base station should be monitored is fully controlled and managed by the network. The connectivity capability from the mobile station to the serving base station is also controlled by the network (i.e. handover process). Prior art protocols are used to update and control the selection of the candidate base stations. The MS does not initiate any attempts to connect to and associate with the TBS unless a link loss to the SBS occurs. The MS then performs an unpredicted HO process.

Further, in prior art MS connectivity and association techniques, the selection of a base station for handover, including handover initiation and control, is based on the direct instruction of and with the assistance of support information provided by the serving base station. The user equipment may be instructed by the serving base station, during the handover preparation stage, to perform measurements of specific signals from and to perform an association process with a certain base station according to a specific schedule.

The ability to perform quick handovers is becoming increasingly important, especially in light of the fact that in the next generation of mobile communication networks, the radius of the cell will become smaller, causing more frequent handovers and disconnection of existing handover calls if the channel capacity for handover is insufficient. One of the major problems in mobile communications, however, is how to optimize (i.e. minimize) the discontinuity and unavailability caused by handovers in broadband wireless networks. Typically, mobile stations must negotiate or receive pre-allocated opportunities for measuring and establishing an association with neighboring base stations and in these unavailability periods the MS is unavailable to the SBS and therefore faces service discontinuities.

The length of the discontinuity period during the HO execution phase may be affected by any or all of the following: (1) uncertainties related to the actual link condition from the MS to the target base station and to the serving base station which may lead to loss of network connectivity and a long synchronization period before the handover process is successfully completed; (2) not being able to maintain suitable quality of service (QoS) in terms of service continuity due to poor network connectivity, complete loss of network connectivity or overload at the SBS; (3) the addition of radio frequency (RF) circuitry and CPU processing capability which increases the cost of manufacturing the mobile station, i.e. the quality of the MS; (4) the inability to acquire the target base station parameters (i.e. from serving base station advertising or otherwise) creating the need to establish link level connectivity and full network connections; (5) the inability to provide necessary SBS control support for existing connections (6) the requirement for specific coordination between the base stations to manage the mobile station air interface resources and service continuity; and (7) the long acquisition time required to obtain (i.e. discover and detect) target base station synchronization and decoding parameters, control information and messages due to any previous acquisition being preformed a long time ago.

The result of the problems described above is to significantly extend the execution time for the handover HO execution phase and MS unavailability during the HO preparation phase to significantly degrade the probability of achieving a successful handover while maintaining a sufficient level of network connectivity and QoS to prevent the interruption of user connectivity.

Thus, there is a need for a mechanism that is capable of improving the quality and reliability of the handover process between a mobile station and multiple network elements while minimizing or eliminating the air link and service discontinuity time due to handover in wireless communication networks.

### SUMMARY OF THE INVENTION

Accordingly, the present invention provides a novel and useful apparatus for and method of autonomous anonymous MS association in cellular communications systems. The autonomous anonymous association mechanism of the present invention optimizes the handover process and system QoS level by decreasing the period(s) that the MS is unavailable, improving parameter acquisition and selection of target base stations, by optimizing the discontinuity period from the time of disconnection from a serving base station and connection to a target base station and by establishing anonymous bidirectional communications with base stations prior to HO formal execution phase. The autonomous association mechanism significantly improves the overall QoS in cellular communications systems, especially the quality and reliability of the handover process by the use of a novel autonomous association methodology between a mobile station and a plurality of network elements.

The mechanism of the invention improves handover in cellular communication systems by optimizing the discontinuity period during the handover procedure and decreasing the drop ratio (i.e. the failure to connect to the TBS). The mechanism is operative to improve the reliability of the handover process and reduce the service discontinuity time due to handovers in communication systems such as Broadband Wireless Access (BWA) networks. The mechanism is applicable to a MS using either a single RF receiver or multi-RF (i.e. wideband) receiver. The mechanism facilitates anonymous multiple cell association in a common or distributed BW allocation in a network unaware manner (i.e. autonomous multi-cell association at the serving base station and the target base station without any intervention by the network) while preserving single endpoint connectivity. The mechanism works without any modification to current access protocols.

Thus, in accordance with the invention, the MS does not need to negotiate for or receive pre-allocated opportunities from the network to perform associations with neighboring base stations. Further, association opportunities are created by the user equipment autonomously and anonymously in accordance with current activity patterns, thereby eliminating any bandwidth waste. The association opportunities are used by the user equipment to exchange preliminary information needed by a base station and MS to establish a bidirectional link and to maintain a real time and a non real time database of candidates for target base stations (i.e. neighboring cells). The databases can be based on the SBS neighboring list or self discovery and on detection of candidates or a combination of both, wherein the parameter set tracked includes (1) parameters that can be measured without any assistance from the target base station, (2) information exchanged over a bidirectional link with the base station (e.g., frequency, power, timing information, etc.), and (3) any information that may effect the handover process, such as received signal quality, frequency synchronization, signal power synchronization, etc.

The invention thus provides a mobile station with the capability of performing handovers that optimize the discontinuity period. Advantages of the autonomous association mechanism include (1) minimizing or eliminating altogether the disconnect period from the current serving base station to a selected target base station reception; (2) improving the reliability and connectivity success ratio of the handover process; (3) improving QoS; (4) reduction of HO overhead; and (5) enabling autonomous multi-cell association without any awareness by or assistance from the network while maintaining single endpoint connectivity.

The handover switching time minimization mechanism (or autonomous association mechanism) of the present invention is suitable for use in many types of wireless communication systems without protocol modifications. For example, the mechanism is applicable to broadband wireless access (BWA) systems and cellular communication systems. An example of a broadband wireless access system the mechanism of the present invention is applicable to is the well known WiMAX wireless communication standard. An example cellular communication system the mechanism of the present invention is applicable to is the well known GSM wireless communication system. The mechanism of the invention is also applicable to one of the third-generation (3G) mobile phone technologies known as Universal Mobile Telecommunications System (UMTS), Code Division Multiple Access (CDMA), Enhanced Data rates for GSM Evolution (EDGE) and Wireless Local Area Network (WLAN) wireless communication systems.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method for use on a mobile station connected to a network, the method comprising the steps of selecting a set of one or more candidate target base stations, attempting connecting to the set of one or more candidate target base stations over the same or across a plurality of access technologies, performing autonomous association of one or more candidate target base stations, wherein the autonomous association is performed anonymously while maintaining connectivity to a serving base station and updating the selection based on information exchanged during the autonomous association.

There is also provided in accordance with the invention, a method for use on a mobile station connected to a network, the method comprising the steps of selecting a set of one or more candidate target base stations, attempting connecting to the set of one or more candidate target base stations over the same or across a plurality of access technologies, performing autonomous association of one or more candidate target base stations and initiating a handover procedure to a specific candidate target base station in accordance with information exchanged during the autonomous association.

There is further provided in accordance with the invention, a method of autonomous association between a mobile station and a plurality of target base stations in a network, the method comprising the steps of detecting potential target base stations in the network to generate a candidate target base station list, performing signal discovery and detection measurements on the candidate target base stations over the same or across a plurality of access technologies, autonomously performing ranging over an uplink channel to one or more candidate base stations to exchange information and perform timing, power and frequency synchronization prior to handover with a base station, updating the candidate target base station list in accordance with information exchanged during the step of ranging.

There is also provided in accordance with the invention, an apparatus for performing association between a mobile station and a plurality of target base stations in a network comprising a modem operative to receive and transmit radio frequency (RF) signals over the network, the modem comprising a cellular connectivity decoder, a memory for storing candidate target base stations and parameter information associated therewith, a processor coupled to the modem, the processor operative to detect potential target base stations in the network to generate a candidate target base station list, perform signal detection and measurements on the candidate target base stations over the same or across a plurality of access technologies, autonomously perform ranging over an uplink channel to one or more candidate base stations to obtain timing, power and frequency synchronization prior to handover with a base station and update the candidate target base station list with information exchanged during the step of ranging.

There is further provided in accordance with the invention, a mobile station comprising a radio transceiver and associated media access control (MAC) operative to receive and transmit signals over a radio access network (RAN) to a serving base station and to receive signals over the RAN from one or more target base stations, a connectivity unit coupled to the radio transceiver for maintaining connectivity to a plurality of target base stations in a network, an autonomous association unit, the autonomous association unit operative to select a set of one or more candidate target base stations, perform signaling discovery and detection on the set of one or more candidate target base stations over the same or across a plurality of access technologies, perform autonomous ranging to one or more candidate base stations over respective uplink channels to exchange information and perform timing, power and frequency synchronization prior to handover with a base station, update the selection based on information exchanged via the autonomous ranging and a processor operative to send and receive data to and from the radio transceiver, the connectivity unit and the autonomous association unit.

### BRIEF DESCRIPTION OF THE DRAWINGS

The invention is herein described, by way of example only, with reference to the accompanying drawings, wherein:

FIG. 1 is a diagram illustrating an example prior art cellular mobile communications system;

FIG. 2 is a diagram illustrating a prior art handover preparation and execution flow;

FIG. 3 is a block diagram illustrating an example mobile device incorporating the autonomous association mechanism of the present invention;

FIG. 4 is a diagram illustrating an overview of multi-cell association;

FIG. 5 is a diagram illustrating an overview of multi-cell association from a signal intensity perspective;

FIG. 6 is a general block diagram illustrating the multi-cell association user equipment of the present invention;

FIG. 7 is a state diagram illustrating the multi-cell association user equipment state machine;

FIG. 8 is a diagram illustrating autonomous association state functionality and the reduced handover requirements using the mechanism of the present invention;

FIG. 9 is a diagram illustrating the multi-cell association from the mobile station to the network in accordance with the present invention;

FIG. 10 is a diagram illustrating multi-cell association detection state functionality;

FIG. 11 is a diagram illustrating handover preparation and execution flow with the multi-cell association mechanism of the present invention;

FIGS. 12A and 12B are a flow diagram illustrating the general multilevel discovery, detection, decoding and association method of the present invention;

FIG. 13 is a diagram illustrating the candidate base station selection, association and handover initiation process;

FIG. 14 is a diagram illustrating and example mechanism for TBS and CBS selection, association and handover initiation;

FIG. 15 is a block diagram illustrating an example multi-cell connectivity and association WiMAX receiver constructed in accordance with the present invention;

FIGS. 16A and 16B are a flow diagram illustrating a multilevel discovery, detection, decoding and association method of candidate base stations for WiMAX networks;

FIG. 17 is a block diagram illustrating an example multi-cell connectivity and association GSM receiver constructed in accordance with the present invention; and

FIG. 18 is a flow diagram illustrating a multilevel discovery, detection, decoding and association method of candidate base stations for GSM networks.

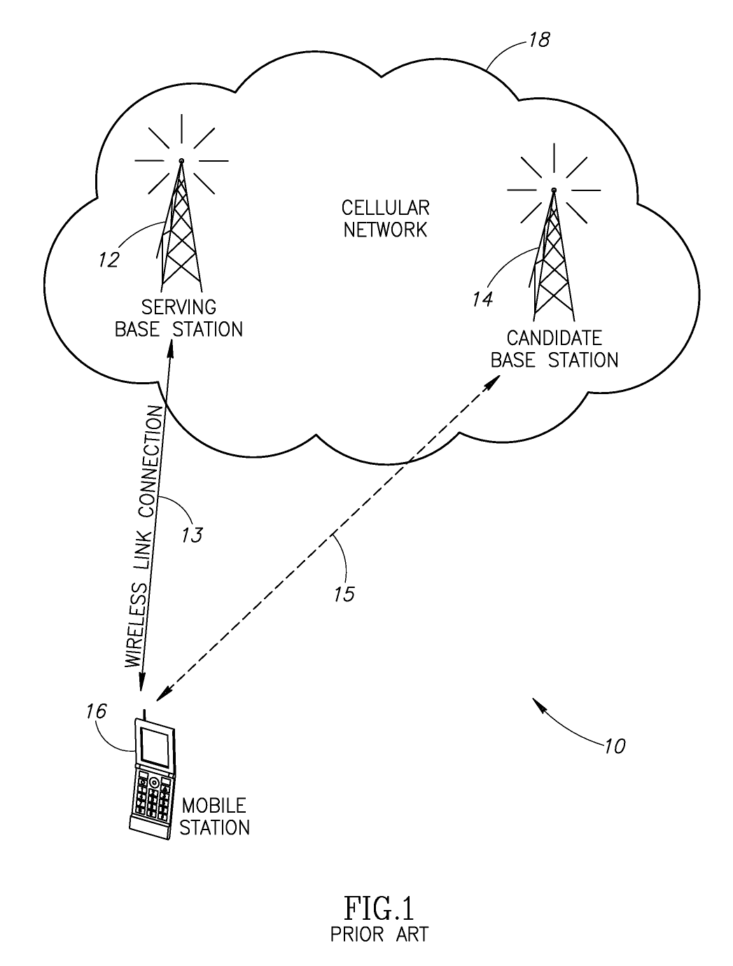

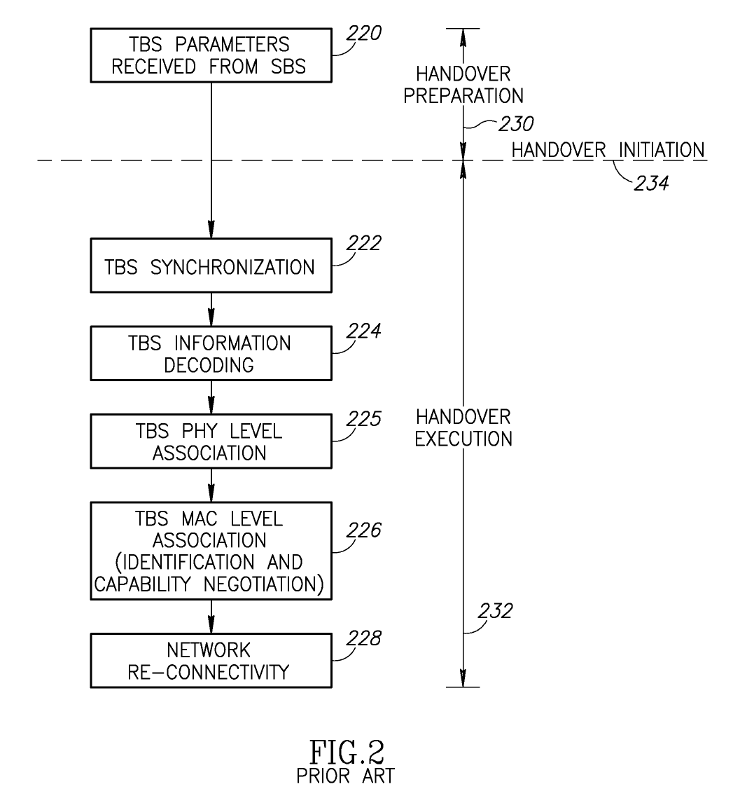

### DETAILED DESCRIPTION OF THE INVENTION

### Notation Used Throughout

The following notation is used throughout this document.

| Term | Definition |
|---|---|
| ABS | Anchor Base Station |
| AC | Alternating Current |
| AGCH | Absolute Grant Channel |
| ASIC | Application Specific Integrated Circuit |
| BA | BCCH Allocation |
| BB | Baseband |
| BCCH | Broadcast Control Channel |
| BER | Bit Error Rate |
| BLER | Block Error Rate |
| BLER | Block Error Rate |
| BS | Base Station |
| BW | Bandwidth |
| BWA | Broadband Wireless Access |
| CBS | Candidate Base Station |
| CC | Connection Context |
| CDMA | Code Division Multiple Access |
| CE | Channel Estimation |
| CID | Connection ID |
| CINR | Carrier to Interferences and Noise Ratio |
| CIR | Committed Information Rate |
| CP | Cyclic Prefix |
| CPU | Central Processing Unit |
| CQI | Channel Quality Indicators |
| CTBS | Candidate Target Base Station |
| DC | Direct Current |
| DCD | Downlink Channel Descriptor |
| DIUC | Downlink Interval Usage Code |
| DL | Downlink |
| DL-MAP | Downlink Medium Access Protocol |
| EDGE | Enhanced Data rates for GSM Evolution |
| FA | Frequency Allocation |
| FB | Frequency Burst |
| FCCB | Frequency Control Channel Burst |
| FCCH | Frequency Correction Channel |
| FCH | frame control header |
| FDMA | Frequency Division Multiple Access |
| FEC | Forward Error Correction |
| FFT | Fast Fourier Transform |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid Automatic Repeat Request |
| HDL | Hardware Description Language |
| HO | Handover |
| ID | Identification |
| IE | Information Element |
| IEEE | Institute of Electrical and Electronic Engineers |
| IF | Intermediate Frequency |
| IFFT | Inverse Fast Fourier Transform |
| KPI | Key Performance Indicators |
| LAC | Location Area Code |
| LAN | Local Area Network |
| MAC | Media Access Control |
| MBS | Multicast and Broadcast Service |
| MNC | Mobile Network Code |
| MOB-NBR-ADV | Mobile Neighbor Advertisement |
| MPDU | MAC PDU |
| MS | Mobile Station |
| NMT | Nordic Mobile Telephony |
| PAGCH | Packet Access Grant CHannel |
| PBCCH | Packet Broadcast Control Channel |
| PBCCH | Packet Broadcast Control Channel |
| PC | Personal Computer |
| PCI | Peripheral Component Interconnect |
| PDA | Personal Digital Assistant |
| PDSN | Packet Data Serving Node |
| PDU | Protocol Data Unit |
| PER | Packet Error Rate |
| PIR | Peak Information Rate |
| PN | Pseudo Noise |
| PRACH | Packet Random Access CHannel |
| PRBS | Pseudo Random Binary Sequence |
| PSI | Packet System Information |
| QoS | Quality of Service |
| RAC | Routing Area Code |
| RAM | Random Access Memory |
| RAN | Radio Access Network |
| RAT | Radio Access Technology |
| RF | Radio Frequency |
| RNC | Radio Network Controller |
| ROM | Read Only Memory |
| RSSI | Receive Signal Strength Indication |
| RTD | Round Trip Delay |
| SBS | Serving Base Station |
| SCH | Synchronization burst |
| SDIO | Secure Digital Input/Output |
| SIM | Subscriber Identity Module |
| SPI | Serial Peripheral Interface |
| TBS | Target Base Station |
| TDMA | Time Division Multiple Access |
| TS | Training Sequence |
| TV | Television |
| UCD | Uplink Channel Descriptor |
| UE | User Equipment |
| UIUC | Uplink Interval Usage Code |
| UL | Uplink |
| UMTS | Universal Mobile Telecommunications System |
| USB | Universal Serial Bus |
| UWB | Ultra Wideband |
| WCDMA | Wideband Code Division Multiple Access |
| WiFi | Wireless Fidelity |
| WiMAX | Worldwide Interoperability for Microwave Access |
| WLAN | Wireless Local Area Network |

### DETAILED DESCRIPTION OF THE INVENTION

The present invention is a novel and useful apparatus for and method of autonomous MS association in cellular communications systems. The autonomous association mechanism of the present invention optimizes the handover process and system QoS level by decreasing the period(s) that the MS is unavailable, improving parameter acquisition and selection of target base stations, by optimizing the discontinuity period from the time of disconnection from a serving base station and connection to a target base station and by establishing anonymous bidirectional communications with base stations. The autonomous association mechanism significantly improves the overall QoS in cellular communications systems, especially the quality and reliability of the handover process by the use of a novel autonomous association methodology between a mobile station and a plurality of network elements.

The mechanism of the invention improves handover in cellular communication systems by optimizing the discontinuity period during the handover procedure and decreasing the drop ratio (i.e. the failure to connect to the TBS). The mechanism is operative to improve the reliability of the handover process and reduce the service discontinuity time due to handovers in communication systems such as Broadband Wireless Access (BWA) networks. The mechanism is applicable to a MS using either a single RF receiver or multi-RF (i.e. wideband) receiver. The mechanism facilitates anonymous multiple cell association in a common or distributed BW allocation in a network unaware manner (i.e. autonomous multi-cell association at the serving base station and the target base station without any intervention by the network) while preserving single endpoint connectivity. The mechanism works without any modification to current access protocols.

The handover switching time minimization mechanism (or autonomous association mechanism) of the present invention is suitable for use in many types of wireless communication systems without protocol modifications. For example, the mechanism is applicable to broadband wireless access (BWA) systems and cellular communication systems. An example of a broadband wireless access system the mechanism of the present invention is applicable to is the well known WiMAX wireless communication standard. An example cellular communication system the mechanism of the present invention is applicable to is the well known GSM wireless communication system. The mechanism of the invention is also applicable to one of the third-generation (3G) mobile phone technologies known as Universal Mobile Telecommunications System (UMTS), Code Division Multiple Access (CDMA), Enhanced Data rates for GSM Evolution (EDGE) and Wireless Local Area Network (WLAN) wireless communication systems.

To aid in illustrating the principles of the present invention, the autonomous association mechanism is presented in the context of both a WiMAX and GSM communication system. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, LTE, CDMA-2000, EVDO, EVDV, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The term mobile station is defined as all user equipment and software needed for communication with a network such as a RAN. The term mobile station is also used to denote other devices including, but not limited to, a multimedia player, mobile communication device, cellular phone, node in a broadband wireless access (BWA) network, smartphone, PDA and Bluetooth device. A mobile station normally is intended to be used in motion or while halted at unspecified points but the term as used herein also refers to devices fixed in their location.

The word ‘exemplary’ is used herein to mean ‘serving as an example, instance, or illustration.’ Any embodiment described herein as ‘exemplary’ is not necessarily to be construed as preferred or advantageous over other embodiments.

The term connectivity (autonomous or non-autonomous) refers to a receive only process whereby the MS only listens to transmissions from one or more base stations. The term association refers to the establishment of a bidirectional link and subsequent two-way exchange of information.

The terms ‘autonomous association,’ ‘autonomous multi-cell association,’ ‘handover switching time minimization’ and ‘handover optimization’ are all intended to refer to the mechanism of the present invention which provides autonomous association between a user equipment (MS) and multiple candidate target base stations. The mechanism autonomously and anonymously maintains simultaneous and non simultaneous, real time and non real time, bidirectional connectivity to multiple network elements for the purpose of exchanging information needed by a base station to establish a bidirectional link in order to reduce or eliminate service discontinuity time during the handover process.

Note that the present invention assumes connectivity (achieved prior to association) is achieved using any means well-known in the art. An example of a connectivity scheme suitable for use with the present invention is described in more detail in U.S. application Ser. No. 12/124,391, filed May 21, 2008, entitled “Autonomous connectivity between a mobile station and multiple network elements in a wireless communication system”, incorporated herein by reference in its entirety. The connectivity stage includes discovering, detecting, measuring, maintaining, decoding information, connecting into a broadcast transmission and tracking a database of neighbor cells in order to establish receive only connectivity.

The serving base station (SBS) is defined as the base station the mobile station is registered with in the network which provides the air interface connectivity. The connection context (CC) is defined as the complete set of parameters that define to the network the connection capabilities, current connection set and status of a specific mobile station. The target base station (TBS) is defined as a base station that is the target for a handover process. A candidate target base station is a base station that the mobile station or other network element considers a potential target base station in its decision and selection process. The handover process is a transition from the SBS to a selected target base station. The connection context of the MS is provided by the network elements based on authorization, authentication and link status between the SBS to the MS. As part of the handover process, the SBS transfers the connection context to the TBS which becomes the new serving base station before, during and/or after the handover is complete.

Note also that the terms connected base station and serving base station are intended to mean the same thing. Similarly with the following pairs of terms: channel and link; MS and user equipment (UE); source and serving base station; channel and link level connectivity; target cell and TBS; and call and session.

### Mobile Station Incorporating the Autonomous Association Mechanism

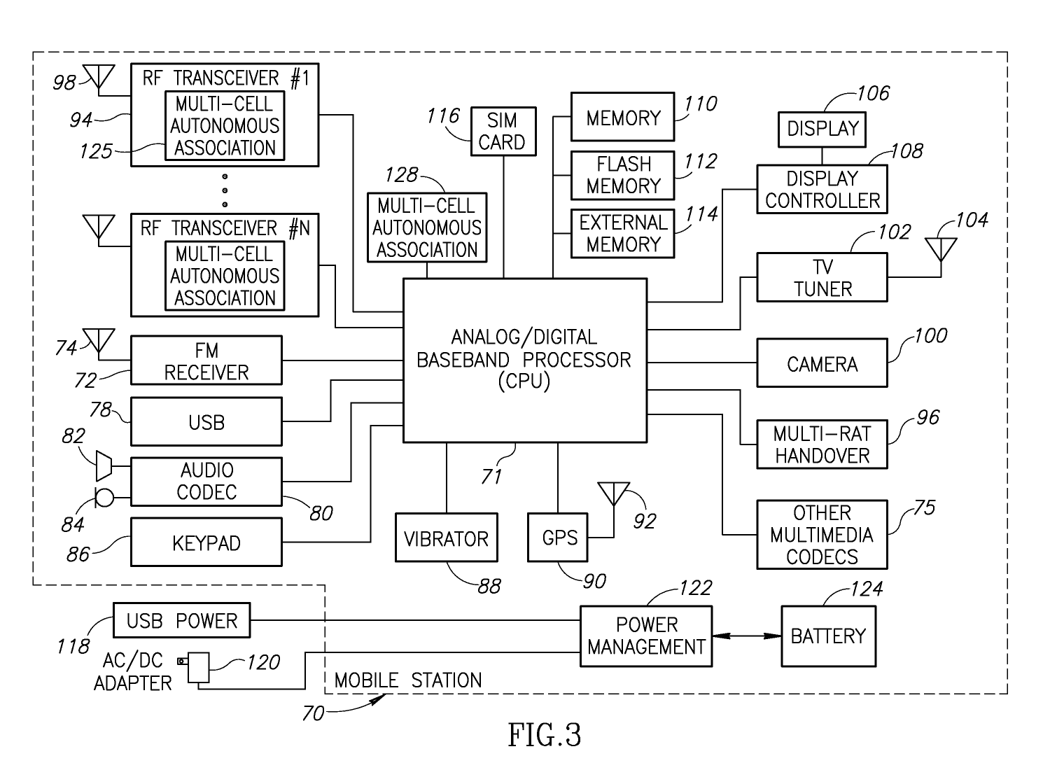

A block diagram illustrating an example mobile device incorporating the autonomous association mechanism of the present invention is shown in FIG. 3. Note that the mobile station may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the autonomous association mechanism of the present invention can be implemented in a wide variety of communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE; 3G; LTE; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60 G device; UWB; etc. One or more of the RF transceivers may comprise an additional a plurality of antennas to provide antenna diversity which yields improved radio performance. The mobile station may also comprise internal RAM and ROM memory 110, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc.

The mobile station comprises a multi-RAT handover block 96 which may be a executed as a task on the baseband processor 71. The mobile station also comprises autonomous multi-cell association blocks 125, 128 which may be implemented in any number of the RF transceivers 94. Alternatively (or in addition to), the autonomous multi-cell association block 128 may be implemented as a task executed by the baseband processor 71. The autonomous multi-cell association blocks 125, 128 are adapted to implement the autonomous association mechanism for inter and intra-access technology HO of the present invention as described in more detail infra. In operation, the autonomous multi-cell association blocks may be implemented as hardware, software or as a combination of hardware and software. Implemented as a software task, the program code operative to implement the autonomous association mechanism of the present invention is stored in one or more memories 110, 112 or 114 or local memories within the Baseband.

Portable power is provided by the battery 124 coupled to power management circuitry 122. External power is provided via USB power 118 or an AC/DC adapter 120 connected to the battery management circuitry which is operative to manage the charging and discharging of the battery 124.

### Autonomous Association Mechanism

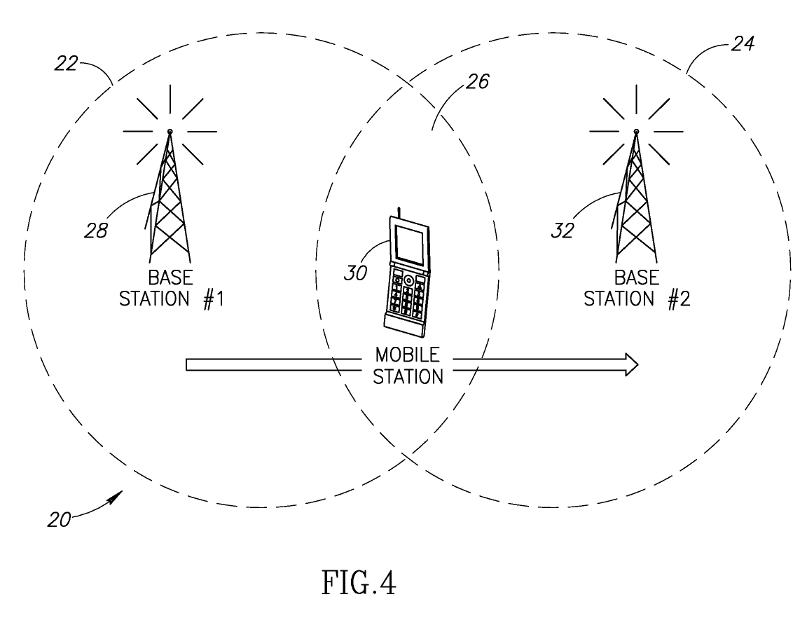

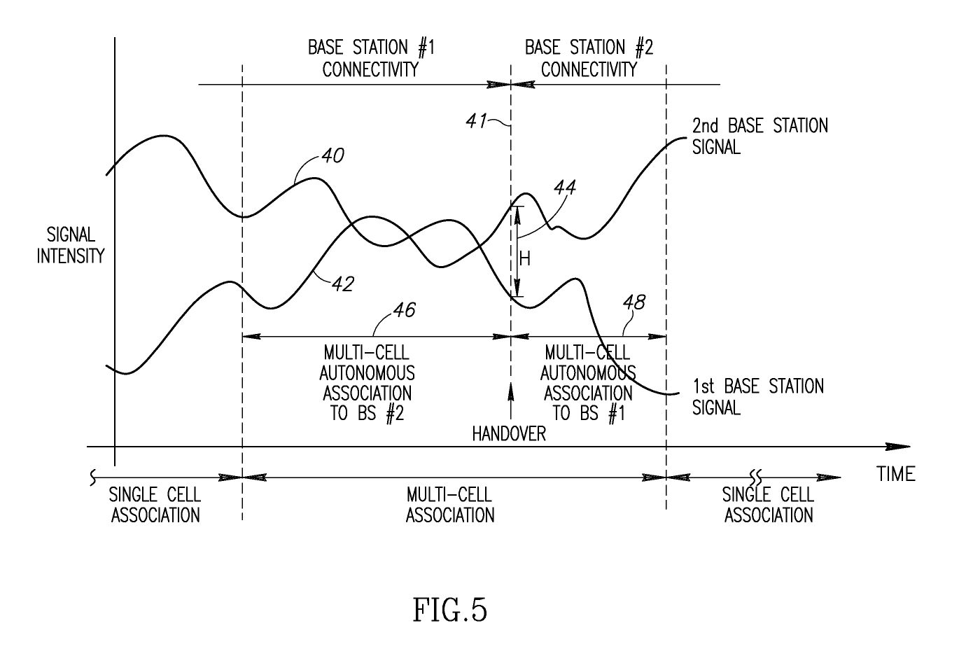

As stated supra, the invention is an autonomous user equipment association mechanism for use in a cellular system (i.e. mobile communications system) internally and between technologies (i.e. inter-RAT). If the user equipment is located in an area where two or more cells overlap in terms of signal strength and or other indicators at the user equipment antenna and reception circuits apparatus, then autonomous user equipment connectivity and association can take place between the cells using the mechanism of the invention. A diagram illustrating an overview of multi-cell association is shown in FIG. 4. The system, generally referenced 20, comprises two cells 22, 24 comprising base station #1 28 and base station #2 32, respectively, and an overlapping region 26. A diagram illustrating an overview of multi-cell association from a signal intensity perspective is shown in FIG. 5. The signal intensity of base station #1 signal 40 declines while the signal intensity of base station #2 signal 42 is increases as the mobile station 30 passes from cell 22 to cell 24.

With reference to FIGS. 4 and 5, it is in the region where the two cells overlap (i.e. in passing from cell 22 to cell 24) that the mobile station 30 performs the autonomous association mechanism. At some point (dashed line HANDOVER 41) the measurements of the signal strength and/or other parameters and the information exchanged with the base station #2 cause the connection of the mobile station to switch from base station #1 to base station #2. Outside of the overlapping region 26, the mobile station remains in single cell association. Single cell connectivity and association of BS #1 is maintained up to the time of handover 41. Similarly, single cell connectivity and association of BS #2 is maintained from the time of handover 41 and beyond.

Within the overlapping region, where the signal strength at the mobile station from both base stations is sufficient, multi-cell association is maintained. Using the autonomous association mechanism, the mobile station optimizes the handover process by improving the monitoring and selection of the target base station based and optimizing the discontinuity period between SBS disconnect and TBS connect by establishing a bidirectional link with one or more target base stations and exchanging information thereover. During period 46, a multi-cell association connection is maintained to BS #2, while the connection to BS #1 is maintained. Similarly, during period 48, a multi-cell association connection is maintained to BS #1, while the connection to BS #2 is maintained.

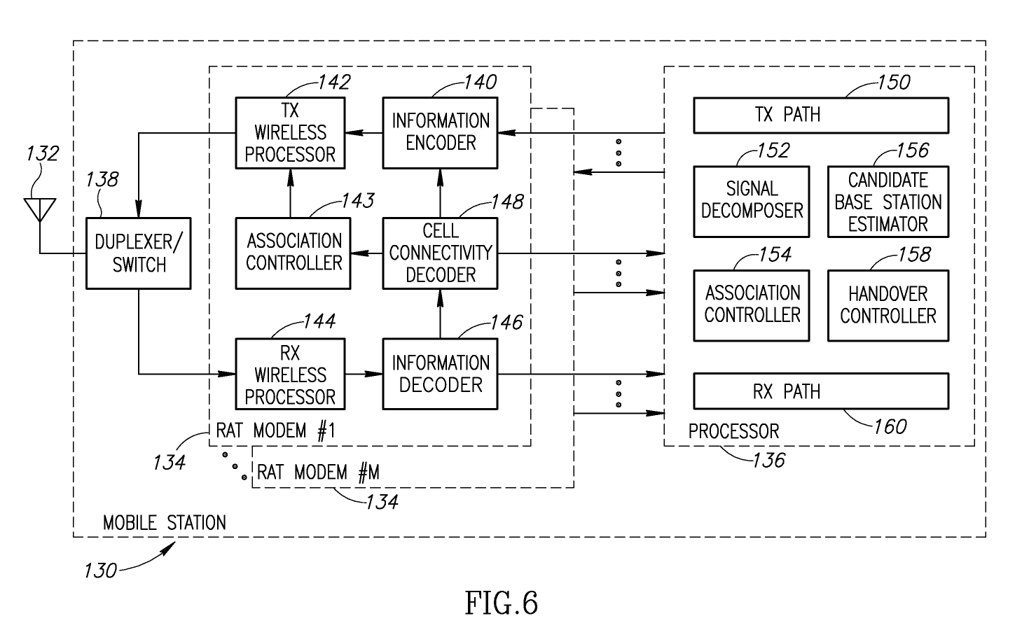

A general block diagram illustrating the multi-cell association user equipment of the present invention is shown in FIG. 6. The mobile station, generally referenced 130, comprises a processor block 136 and a plurality of RAT modem blocks 1 through M. Each modem block is operative to receive and transmit a different radio access technology (RAT). In addition, each modem block 134 is coupled to a corresponding antenna 132 via duplexer/switch 138. Note that for clarity sake, only one switch and antenna are shown. Depending on the implementation, however, the antenna and switch may or may not be shared among the plurality of RAT modems. Each modem block 134 comprises an information encoder 140, TX wireless processor 142, RX wireless processor 144, information decoder 146, cell connectivity decoder 148 and association controller 143. The processor block 136 comprises a TX path circuit 150 for providing TX data to the modem, RX path circuit 160 for receiving RX data from the modem, signal decomposer block 152, association controller block 154, candidate base station estimator 156 and handover controller 158.

It is important to note that the scope of the invention is not limited to systems with only a single RAT. The invention is suitable for use in systems that have the ability to switch between cells corresponding to different RATs. An MS incorporating the invention and comprising multiple-RAT modems is able to simultaneously receive information and associate into multiple cells having different RATs and access technologies. Thus, a handover process may involve switching from one RAT to another. In both the multiple-RAT and single RAT cases, the autonomous association mechanism of the invention is operative to improve the reliability of the handover process and reduce the service discontinuity time.

Preferably, the modem comprises a wideband receiver that is capable of receiving multiple RF signals from single or multi-access technologies. The invention incorporating such an RF receiver has applicability in the following cases which utilizes the invention in a complementary manner to implement current and future wireless communication standards. In a first case, cellular technologies which implement the downlink using the same received bandwidth (i.e. single RF, multiple transmission sources) and which enable signal decomposition of SBS and Candidate TBS (CTBS) transmissions will benefit from an improvement in QoS in terms of service continuity or air link connectivity.

In a second case, cellular technologies which support an RF section having wider receive bandwidth than the minimal bandwidth mandated by the particular standard (thus enabling multiple RF reception from signal or multi access technologies) can utilize it to achieve the same.

In a third case, those cellular technologies which utilize the same receive bandwidth as mandated by the particular wireless standard (i.e. single RF, single source) but implement time duplexing may make use of inactivity periods for reception of candidate target base stations without incurring service interruptions.

In a fourth case, those implementations that can utilize standard support requests from the serving base station for absence (inactive) periods (which will prevent data loss but may impact service) will benefit in an improvement in QoS in terms of service continuity or air link connectivity.

The multi-cell receiver enables the mobile station to synchronize to multiple base stations via a downlink only and to a single base station (SBS) via both an uplink and downlink. In operation, the modem transmits and receives signals to/from the serving base station as well as receives signals from multiple target base stations. The signal decomposer 152 (FIG. 6) in the processor 136 is operative to provide the uplink and downlink for the serving base station as well as control and data (i.e. downlink) for the target base stations regardless of the particular RAT or access technology involved.

To enable the mobile station to perform associations with several cells concurrently (each base station comprising another cell), an association is performed with each individual cell at both the PHY level and the MAC level via the association controller block 154. During association, a bidirectional link is established and preliminary information needed for handover is exchanged between the MS and base station. Note that it is assumed that the association controller or some other entity performs basic connectivity functions such as detection, downlink decoding, identification and synchronization to candidate base stations, using techniques well-known in the art.

The signal decomposer functions to decode protocol date units (PDUs) (i.e. packets, frames, etc.). The mobile station then makes use of MAC level broadcast, multicast or unicast messages and PHY level detection to synchronize to base stations in neighbor cells. For example, PHY level detection of MAC level messages is used to detect the preamble ID in IEEE 802.16 WiMAX messages. It is important to note that implementing connectivity does not require the decoding of MAC messages, as the information at the PHY level is sufficient.

During the connectivity stage, once able to detect and receive MAC messages, the mobile station attempts to decode MAC level PDUs. If the mobile station is able to decode the MAC level PDUs, the base station parameters are then identified and compared against criteria. If the base station parameters are determined to be suitable, the mobile station then identifies the particular base station as a suitable candidate target base station (CTBS). The CTBSs selected are stored in a group or database the contents of which are used in subsequent handover procedures.

In accordance with the present invention, once connectivity is established, the MS attempts an association with the candidate base stations. During the association stage, the MS autonomously and anonymously transmits signals to and receives feedback from the TBS. According to the received signals and feedback, the MS is able to tune transmission parameters in a precise manner. The MS and base station also exchange information related to capabilities, negotiate parameters, services, etc. without knowledge of the network.

Note the mobile station is not required to negotiate for or receive pre-allocated opportunities for creating associations with neighboring base stations. The association opportunities are created and managed by the mobile station itself in an autonomous manner in accordance with instantaneous activity patterns and the particular wireless standard protocol implemented.

Normally, networks allocate measurement and association opportunities to the mobile station. These can be either explicit or implicit as a function of the protocol. For example, in WiMAX, an explicit allocation opportunity follows negotiation. In GSM, an implicit allocation assumes a specific time slot at each frame is used for this purpose. An idle frame inserted every 13 frames can be used for measurements that require more than half a time slot. In most cases, the allocation of the measurement and association opportunity is negotiation based.

Further, prior art mobile stations measure and perform associations with neighbor cells using only the opportunities provided by the protocol. If there is need to decode data from a base station other than the serving base station, the mobile station must explicitly request an inactivity period.

These measurement and association opportunities are used by the mobile station to measure parameters and establish a bidirectional link to exchange information with the base station. Using these parameters and feedback information (also referred to as PHY and/or MAC level elements), the mobile station builds and maintains a database of neighbor cells that contain both relevant and irrelevant candidates for HO. The feedback information and parameter set that is tracked preferably comprises the complete set of feedback information and parameters (especially those that can affect the handover process) that can be measured without any assistance from the source base station or received by the MS from the targets base station over a bidirectional link. The target base station feedback information and parameters, acquired or transmitted from the base station and received by the MS may include, for example, received signal quality, synchronization information (in frequency and time), network/operator ID, cell type (i.e. macro, micro or pico) and service capabilities (e.g., current load).

Example feedback information and parameter sets that may be used for the measurement and association opportunities the results of which are used to build and maintain a database of neighbor cells is described below. It is appreciated by those skilled in the art, that zero or more of the feedback information and parameters sets and any number of feedback information and parameters within each set may be used and in any combination. Note that the term ‘elements’ is meant to refer to PHY and/or MAC level parameters, feedback information, measurements or criteria.

The first set comprises parameters whose values are derived from intra-frequency measurements carried out by intra-frequency measuring means or via an association process (UL or DL) on the estimated channel that extends between the BS and the corresponding MS. Optional parameters include: Channel Quality Indicators (CQI), Carrier to Interferences and Noise Ratio (CINR) mean, CINR standard deviation, Received Signal Strength (RSS) mean, RSS standard deviation, timing adjustment, offset frequency adjustment, optimal transmission profile, and the like, and any combination thereof.

A second set comprises parameters whose values are derived from inter-frequency measurements carried out by inter-frequency measuring means or via an association process (UL or DL) on channels other than the estimated channel. Such optional parameters include: CQI, CINR mean, CINR standard deviation, RSSI mean, RSSI standard deviation, timing adjustment, offset frequency adjustment, optimal transmission profile, etc. and any combination thereof.

A third set comprises parameters whose values are derived from intersystem measurements carried out by intersystem measuring means or via an association process (UL or DL). Such optional parameters include: current transmit power, maximum transmit power, power headroom, internal measurements on the equipment, etc. and any combination thereof.

A fourth set comprises parameters that relate to MS positioning measurements carried out by positioning measuring means or via an association process (UL or DL). Examples of such parameters include: position indication using GPS or other triangular systems, time offset (propagation time), propagation loss, etc.

A fifth set comprises parameters relate to measurements of the traffic volume carried out by traffic volume measuring means or via an association process (UL or DL). Examples of such parameters include the amount of transmission units (bit, packet, burst of packets, frames, blocks, etc.) transmitted successfully/failed, for every link, connection, session, etc. existing or in holding between the managing and managed entities.

A sixth set comprises parameters that relate to measurements of the quality of the link carried out by link quality measuring means or via an association process (UL or DL). Examples of such parameters include: Traffic Peak Rate/PIR with the time base for calculation, traffic rate deviation, latency, jitter, loss ratio, CIR fulfillment, voice quality, grade of service indications, BER, PER, BLER, network Key Performance Indicators (KPI), the amount of time the terminal received information in certain quality during a certain time period , information associated with connection switching, etc.

Measuring, acquiring and receiving (via association) these parameters before the handover process (when required) permits a significant reduction (and possible elimination) in switching time since at the time HO execution starts, the candidate target base station downlink connectivity has already been established and target cell support parameters and status are already known. The continuous tracking of multiple TBSs, permits a significant improvement in hardware switching time since the MS does need to acquire and/or measure parameters to obtain the information required to make handover decisions, as the MS has already obtained the necessary information.

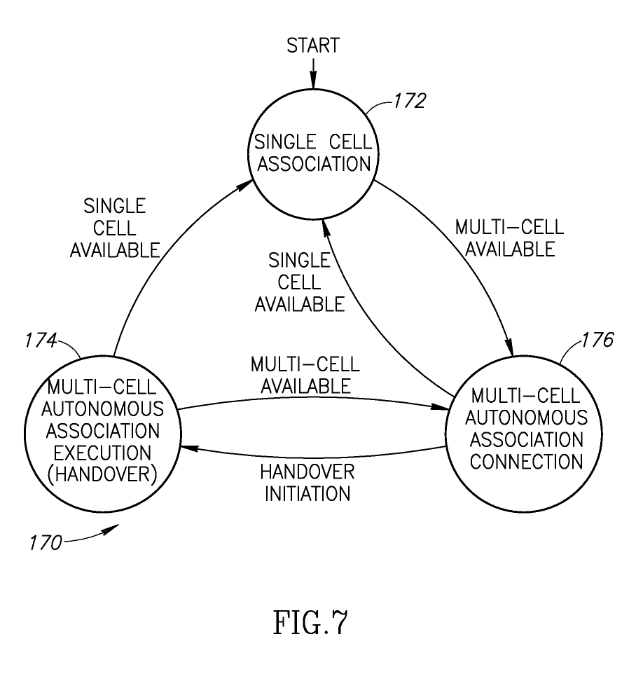

A state diagram illustrating the multi-cell association user equipment state machine is shown in FIG. 7. The machine, generally referenced 170, comprises a signal cell association state 172, multi-cell autonomous association connection state 176 and a multi-cell autonomous association execution (handover) state 174. Operation begins in the single cell association state. In this state, association is performed with only a single cell. If multi-cell association is possible while in state 172 or state 174, the machine transitions to state 176. In this state, the MS connects autonomously and anonymously to one or more TBSs while associating with the serving base station.

While in state 176, a handover initiation causes a transition to state 174. In this state, the MS has selected one of the TBSs previously connected to and associated with in state 176. Permission is received from the network to associate with the base station and the ID stage and network ID stages are completed thus connecting to the new TBS that becomes the SBS. Note that the availability of single cell association while in state 176 or state 174 causes a transition to state 172.

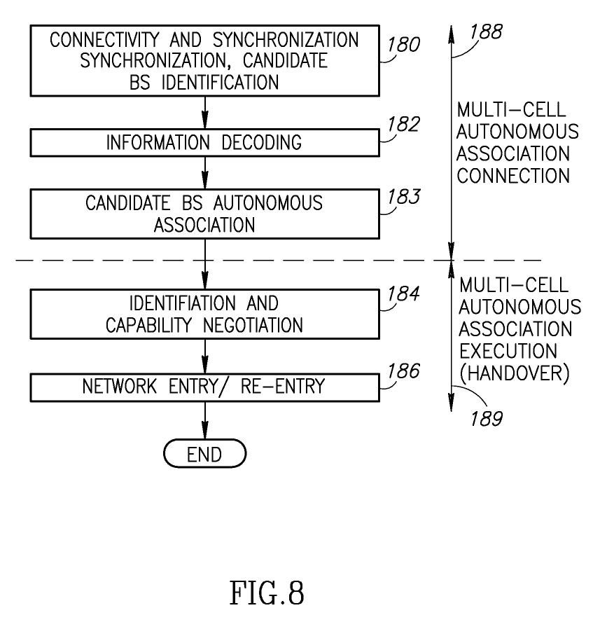

A diagram illustrating autonomous association state functionality is shown in FIG. 8. In the handover preparation stage 188 (i.e. the multi-cell autonomous association connection stage), the mobile station connects to, synchronizes with decodes information from and performs association with multiple target base stations. First, connectivity and synchronization is established with the serving base station and multiple target base stations (step 180). During this step, the MS receives PHY and possibly MAC level information and identifies one or more candidate base stations. The MS then decodes the downlink (DL) information received from the TBSs (step 182). At this point, the MS is able to connect to base stations and generate a list of candidate base stations.

Autonomous association with the candidate stations is then performed (step 183). During this step, bidirectional links with the candidate base stations are established for exchanging preliminary information required for the handover process. Information is transmitted from one or more base stations and feedback is provided from the TBSs.

In particular, the MS connects to the TBS without identifying itself to the TBS. This is in contrast with connectivity and synchronization step 180 where the MS only listens and passively analyzes reception, signal loss, etc. and determines the list of candidate base stations. The scanning, searching, etc. is performed using only the receiver, decoding broadcast info, etc.

In the autonomous association step 183, the bidirectional connection is used to transmit signals to and receive feedback from the TBS, e.g., relative error regarding power, frequency, etc. Depending on the signals received, the MS can tune the transmit parameters, power, frequency, timing, etc. and the feedback mechanism in a precise manner in order to be fully compliant with the TBS. In addition, the MS and TBS also exchange capability, negotiate services and parameters, etc. The connection to the TBS is made without the knowledge of the network. Note that it is assumed that prior to the association stage, the MS obtained knowledge of the TBS. The actual method or technique used to obtain knowledge of the TBS is not critical to the invention.

Thus, the autonomous association mechanism of the present invention reduces the risk of not being able to connect to the TBS during an actual handover. Without the benefit of the autonomous association mechanism, it is not known whether a connection to the TBS is really possible. The only information that can be relied on is that sent by the network thereby leaving a certain probability of not being able to connect to the network. Thus, use of the autonomous association mechanism increases the probability of performing a successful handover.

In the handover execution stage (i.e. multi-cell autonomous association execution stage) 189, the MS performs identification and capability negotiation (step 184) between the mobile station and the target base stations, selects a TBS and establishes network connectivity to the selected TBS. The network then connects/re-connects to the new TBS (step 186).

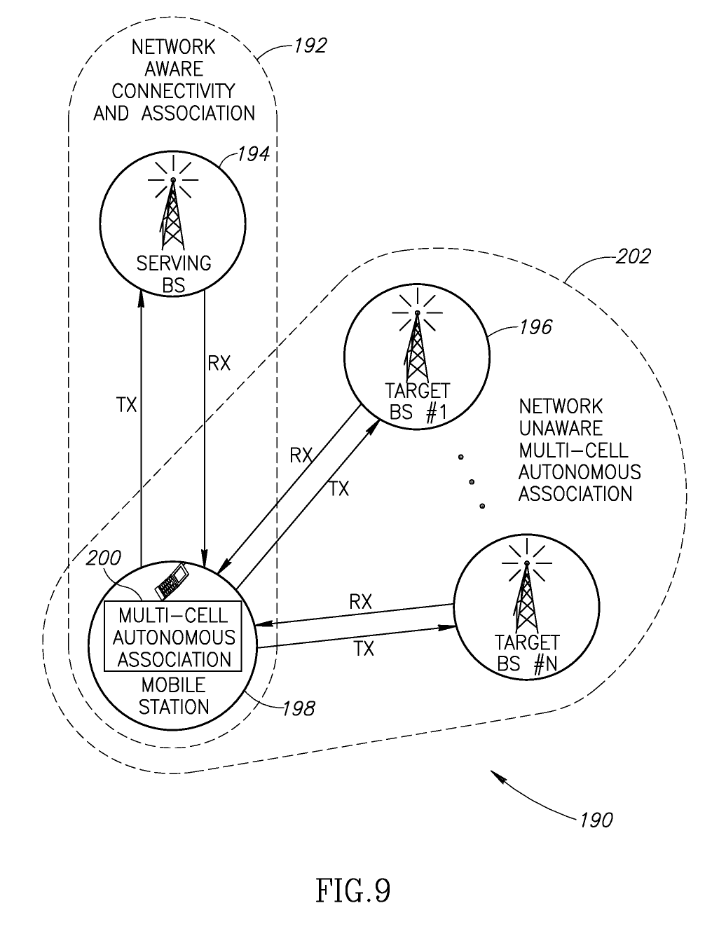

A diagram illustrating the multi-cell association from the mobile station to the network in accordance with the present invention is shown in FIG. 9. The example network, generally referenced 190, comprises a mobile station 198 that maintains both network aware connectivity and association 192 and network unaware multi-cell autonomous association 202. The mobile station incorporates the autonomous multi-cell autonomous association mechanism 200 of the present invention and is synchronized, registered with and maintains both uplink (UL) and downlink (DL) connections to a serving base station 194. This connection constitutes the network aware connectivity portion 192.

In accordance with the invention, the network unaware multi-cell autonomous association portion 202 is also maintained by the mobile station wherein one or more candidate target base stations (CTBSs) 196, labeled target base station 1 through N, are connected via both downlinks and uplinks to the mobile station. The mobile station is connected to the target base stations to acquire parameters and exchange preliminary information before a handover in order to reduce handover switching latency. Note that the mobile station is connected to the multiple base stations (CTBSs) via downlinks and uplinks while maintaining full connectivity (i.e. DL and UL) with a single serving base station. The SBS is aware of the connectivity with the mobile station and thus it maintains network aware connectivity. In accordance with the invention, the CTBSs (TBS 1 to TBS N) are unaware of the connectivity and association to the mobile station as all parameters for this connectivity and association where obtained without any network support for the mobile station.

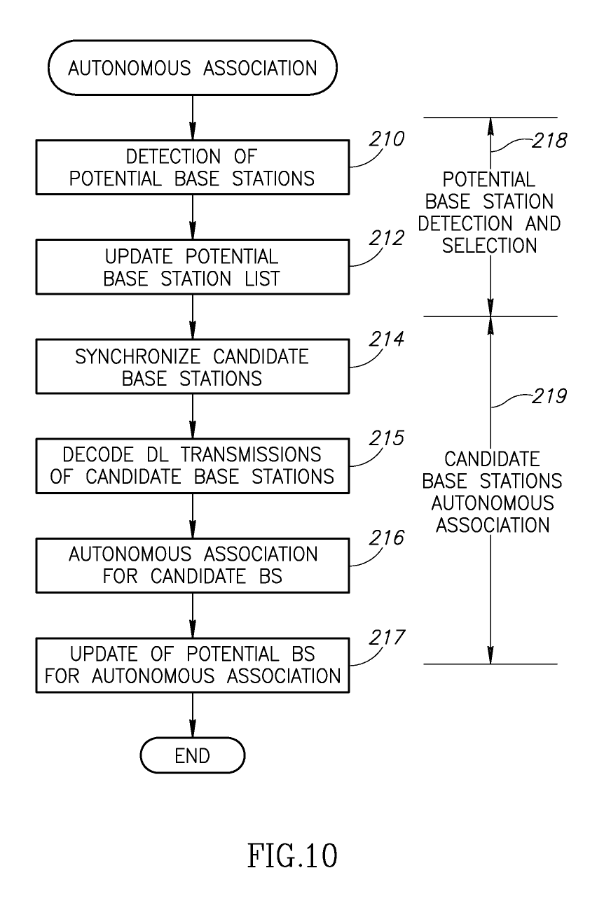

A diagram illustrating autonomous association functionality (at the HO preparations stage) is shown in FIG. 10. The mobile station first detects and selects potential target base stations (218). This includes discovery and detection of potential base stations (step 210) and updating a potential base station list that is maintained by the mobile station (step 212). The mobile station then associates autonomously with each candidate base station (219). This includes synchronizing with candidate base stations (step 214), decoding DL transmissions of candidate base stations (step 215), autonomous association for candidate base stations (step 216) and update of potential base stations for autonomous association (step 217).

Note that in synchronizing to a base station in step 214, the user equipment obtains at least a basic set of reception parameters such as time, frequency, timing and identity, for example. Note further that synchronization may occur in band (i.e. the base station is in the same channel) or out of band (i.e. the base station is in a different channel) in the same or different RAT or access technologies.

Note also that target base station information decoding in step 215 involves the decoding of neighbor base station DL broadcast messages and the acquisition of parameters for identifying base station capabilities, base station network identity (e.g., MAC address in IEEE 802.16 networks or BCH in GSM networks), MAPs of resources, connection allocations, etc. Note further that synchronization and target base station information decoding can be performed (1) continuously in parallel to decoding the information from the serving base station or (2) during time gaps between information decoding.

At a point where steps 210, 212, 214 and 215 are complete, the MS does not have full knowledge of the CBSs. The MS does, however, have information on the PHY level that it is missing, e.g., appropriate power level for transmission to the BS. Thus, in step 216 the MS exchanges information related to PHY and MAC (i.e. link) level parameters. This enables the MS to tune various link level parameters, e.g., frequency offset, timing offset, transmit power, etc. Then the MS can negotiate or receive from the TBS information related to the actual load, i.e. QoS parameters, the type of services the TBS offers, etc.

In response to the information feedback from the TBS, the MS updates its choice of potential CBSs. For example, if a base station does not support voice service or does support voice service but without certain features, the MS may choose to connect to a different base station. Any or all of the various parameters, including link level parameters described supra in connection with FIG. 6 may be used by the MS in selecting a base station.

During the autonomous association stage, the mobile station scans (i.e. searches) for candidate target base stations (CTBSs) based on its knowledge of the particular wireless protocol in use. Note that the process of scanning for CTBSs may be performed by the mobile station autonomously (as described in U.S. application Ser. No. 12/124,391, cited supra) or can be performed based on information provided by the serving base station, possibly without any prior knowledge of the particular access technique. The scanning may be performed in one of several ways. It can be a continuous, periodic, mobile station triggered or network triggered process. In addition, the mobile station may use advertising parameters obtained from neighboring network base stations to scan for CTBSs.

The parameters (either measured or acquired) of each CTBS are checked against a criteria (e.g., signal strength above a certain level). The mobile station creates and maintains a candidate target base station list (database or scan set) of candidate target base stations that meet the particular criteria. Based on the scan results (both previous and current), the scan set created defines a set of CTBSs comprising the target base stations to which the mobile station subsequently performs autonomously association with.

In autonomous association to the CTBSs the mobile station maintains a connection to several CTBSs simultaneously. This association enables the mobile station to exchange information with and acquire the CTBS preliminary information and parameters (e.g., synchronization, decoding, network/operator IDs, cell type, etc.) needed to perform handover operations with zero or near zero switching times to the CTBS selected to be the new serving base station. Note that the mobile station may at this stage exchange information with the CTBS simultaneously with that of the serving base station.

In a handover, one of the target base stations is selected as a candidate to be the new serving base station. Although the target base station chosen will typically be found in the candidate target base station list generated previously, it may not be.

The mobile station verifies the connectivity to the target base station. Note that verification only is required, since the mobile station is already connected to the target base station. Using the autonomous association procedure, the mobile station completes the uplink connection to the selected target base station and establishes network connectivity. The target base station now functions as the serving base station.

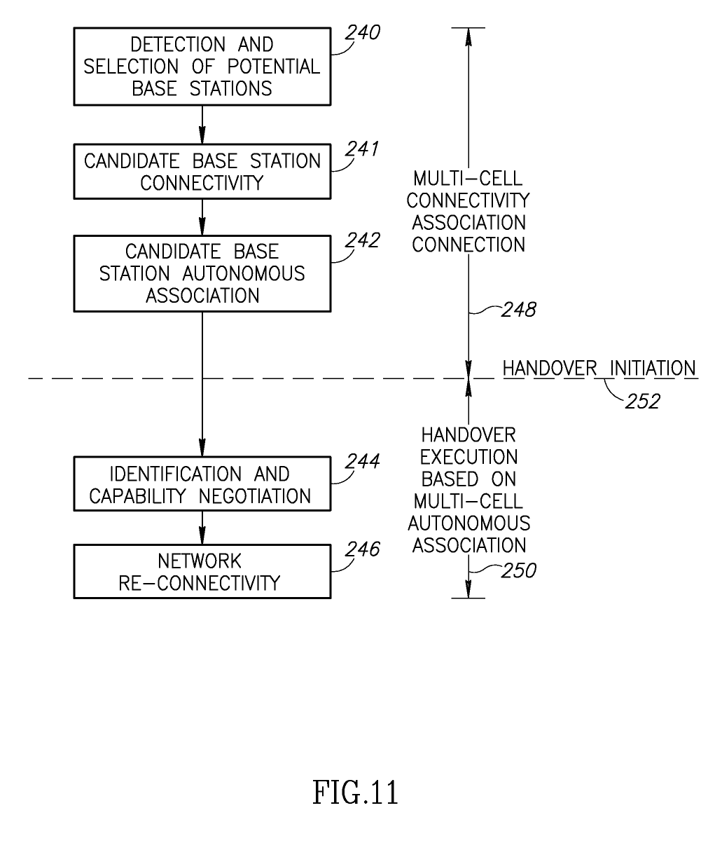

A diagram illustrating handover preparation and execution flow with the multi-cell autonomous association mechanism of the present invention is shown in FIG. 11. During the multi-cell autonomous association connection (248), the mechanism dynamically detects and selects candidate base stations and places them into a candidate base station list (step 240). The candidate base station list may be a subset of a larger list of known base stations. The list represents the current set of base stations that are slated for controlled and/or autonomous monitoring, tracking and association. In other words, the list represents the potential candidates that are handover worthy at a specific point in time. Note that in signaling discovery and detection, control and data information bits are detected. Further, the discovery and detection is performed in accordance with the particular wireless standard in use. Alternatively, the MS may obtain connection related information via means other than by discovery and detection.

The base stations in the candidate base station list are dynamically ranked according to predefined criteria, current measurements and information stored in the user equipment memory (see processor 136, FIG. 6). In a candidate base station connectivity step 241, the new measurements are performed without any specific commands or instruction from the network or the serving base station in all or a portion of the related parameters or dimensions, including schedule, target base station and type of measurement.

Following candidate base station connectivity, candidate base station autonomous association is performed (step 242). As described supra, the MS establishes a bidirectional link with each candidate base station in order to exchange information required for the handover procedure.

Once handover is initiated (dashed line 252) by the MS using TBS monitoring or via other network elements, handover execution (250) includes identification and capability negotiation between the mobile station and the candidate target base station that has been chosen as the target base station (step 244). Network re-connectivity to the target base station is then performed (step 246), however at higher efficiency and flexibility.

Note that autonomous multi-cell association between cells takes place when the user equipment is located in a region where two or more cells overlap in terms of both signal strength and signal quality at the antenna of the user equipment. During autonomous user equipment association, user equipment is in communication (from network point of view) with or registers with a serving base station. While in parallel, the user equipment is operative to concurrently perform autonomous association with several additional candidate base stations. The autonomous user equipment association functions to effectively accelerate what would normally be a “controlled” (i.e. original) handover. Further, by taking advantage of the coverage in overlapping cell regions, handover is performed in a much more efferent manner thereby decreasing the time for the user equipment to move from one cell to another.

As opposed to prior art association techniques, where the selection of a base station for handover is done based on commands and support information received from the serving base station, the mechanism of the present invention accelerates the handover process, and in particular, the period of unavailability between (1) session/s closure at the serving base station and (2) connecting, registering and opening a new session/s with the selected target base station which after completion of the handover process becomes the new serving base station. It is important to note that use of the mechanism of the present invention increases the probability of successfully connecting to the TBS. This is because up to the point of handover, the MS has been continuously monitoring, maintaining connectivity with and conducting association with the TBS and maintains up to date and continuous information and parameters regarding the link, BS capabilities, services, etc. This reduces the probability that a connection to the TBS at the time of handover will be unsuccessful for failure to establish the link.

Thus, in accordance with the mechanism of the invention, once potential base stations are detected and sets of candidate base stations are selected and placed on a candidate base station list, an autonomous association is made with each candidate base station without the need for sending and receiving network advertising information and handover control messages. It is important to note that the association is performed autonomously and in an anonymous manner by the user equipment. An important aspect of the invention is that the autonomous association scheme does not require coordination between the serving base stations or other network elements.

In accordance with the invention, the user equipment does not negotiate for or receive pre-allocated opportunities from the network to perform association with neighbor base stations. Further, measurement and association opportunities are created by the user equipment autonomously in accordance with current activity patterns, thereby eliminating any bandwidth waste. The measurement and association opportunities are used by the user equipment to maintain the database of candidate target base stations (i.e. neighboring cells), wherein the parameter set that is tracked includes those parameters that (1) can be measured without any assistance from the target base station, (2) obtain via information exchange over a bidirectional link with the base station; and (3) may effect the handover process. Example target base station parameters include, but are not limited to, (1) received signal quality, (2) synchronization information (i.e. frequency and time), (3) network/operator ID, (4) cell type (i.e. macro/micro/pico), (5) service capabilities (e.g., current load), etc., (6) any or all of the parameters and parameter sets described supra. It is appreciated that the user equipment may detect other parameters or metrics as well by measurement, information exchange or by other means.

Depending on the implementation, the selection of the candidate base stations may be based on any number of the following parameters: link level measurements, link quality measurements, quality of service and other parameters and criteria, either measured or stored in user equipment memory such as any or all of the parameters or parameter sets described supra, e.g., CQI, CINR mean, CINR standard deviation, RSS mean, RSS standard deviation, timing adjustment, offset frequency adjustment, optimal transmission profile, current transmit power, required transmit power, required power headroom; parameters which relate to the managed entity positioning measurements such as position indication using GPS or other triangular systems, time offset, propagation time, propagation loss, amount or transmission unit (bit, packet, burst of packets, frame, blocks, etc.) transmitted successfully/failed, for every link, connection, session, etc. extending or held between the managing and managed entities; measurements of the quality of the link such as Traffic Peak Rate/Peak Information Rate (PIR) with time base for calculation, traffic rate deviation, latency, jitter, loss ratio, Committed Information Rate (CIR) fulfillment, voice quality, grade of service indications, BER (bit error rate), PER (packet error rate), BlER (Block error rate), network KPI (Key Performance Indicators), etc.

Note that the handover process can be made more effective by selecting an active base station based on a measure of the end-to-end quality of service from the base station to the destination user equipment thereby making it possible to select base stations to add to the candidate base station list based on the best overall end-to-end performance to the destination user equipment.

The mechanism further comprises choosing a candidate base station using threshold values determined by the autonomous association mechanism internally or by other network elements directly (via proprietary or non-proprietary messaging, based on the measure of the link level and quality of service of the candidate base station, information exchanged over a bidirectional link with the base station or on any other parameters such as those described supra. These threshold values are then used at the initiation of the handover process by the user equipment. Note that this provides a convenient mechanism for allowing the user equipment to select the target base station and optimize the handover timing. For example, the threshold values may be based on at least one of the following relative measures: RSSI, BER estimation, motion estimation, modulation and coding scheme, etc.

Preferably, a base station is selected as a candidate base station based also on a measure of radio channel conditions from a user equipment to the particular base station. This permits a base station with good quality radio channel conditions to be selected in preference to a base station with poor radio conditions. In addition, the user equipment dynamically ranks the base stations in the candidate target base station list in accordance with (1) the radio link quality associated with each base station, (2) an estimate of the overall performance in accordance with a predetermined criteria or based on any combination of parameters or parameter sets described supra.

The user equipment selects a candidate base station from the list based also on radio channel past conditions or based on a parallel discovery, detection and association mechanism. The discovery, detection and association mechanism in the user equipment attempts to identify the operating system by classifying them into a relevant radio access technology (RAT). This is achieved by analyzing receive energy or traffic/signaling frames utilized in the operating (i.e. connected) frequency band and in other frequency bands in parallel with normal communications with the serving base station (i.e. transmitted and received information). In the case of WiMAX (i.e. 802.16e radio access technology), for example, the user equipment may detect (i.e. measure) the following signaling elements: preambles, PRBS, PHS and MAPs.

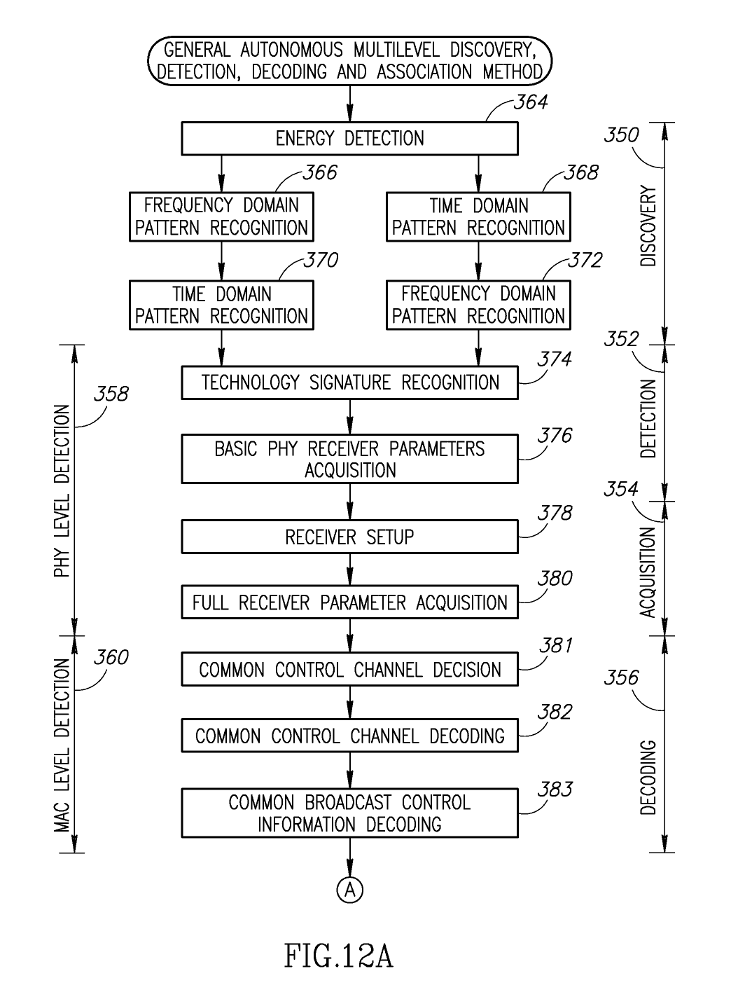

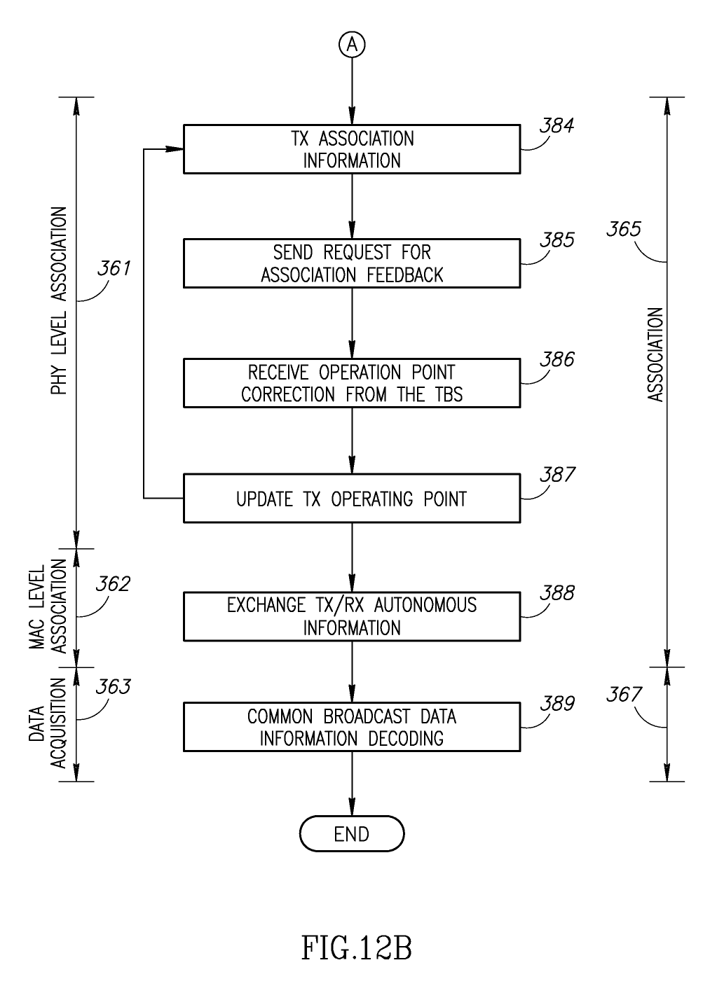

The general multilevel discovery, detection, decoding and association method of the present invention will now be described in more detail. A flow diagram illustrating the general multilevel discovery, detection, decoding and association method of the present invention is shown in FIGS. 12A and 12B. The method is divided into a plurality of stages or phases, namely discovery 350, detection 352, acquisition 354, decoding 356 and association 365 and information decoding 367. PHY level detection 358 encompasses the detection 352 and acquisition 354 stages. MAC level detection 360 encompasses the decoding stage 356. PHY level association 361 and MAC level association 362 encompass the association stage 365. Data acquisition 363 encompasses the information decoding stage 367.

Initially, the MS first detects energy at the appropriate frequency via one or more of the modems 134 (FIG. 6) (step 364). Pattern recognition on the detected energy is performed in the frequency domain (step 366) followed by time domain pattern recognition (step 370). To increase discoverability, the order of pattern recognition is reversed with time domain patter recognition performed (step 368) followed by frequency domain pattern recognition (step 372).

The signals received are matched against known signatures of the various RAT or access technologies (step 374). Using this technique, the basic PHY receiver parameters are acquired (step 376). Based on the receiver parameters acquired, the receiver is then setup (step 378) to permit a full receiver parameter acquisition (step 380). This constitutes the PHY level detection stage 358. In the MAC level detection stage 360, common control channel selection is made (step 381) and decoding of the common control channel is performed (step 382). Further, common broadcast control information is decoded as well (step 383).

In the PHY level association stage 361, a bidirectional link is established candidate base station. TX association information is gathered and analyzed (step 384) and a request for association feedback information is sent to the target base station (step 385). In response, the target base station replies with operating point correction information (step 386). Based on the received information, the MS updates it's transmit operating point (i.e. frequency offset, power control, timing, etc.) (step 387). TX and RX related MAC (link) level information is exchanged autonomous and anonymously with the TBS (step 388) in the MAC level association stage 362. Next, common broadcast channel control information is decoded (step 389) in the data acquisition stage 363.

It is important to note that this process of discovery, detection, decoding and association helps to greatly reduce the overhead of the link since (1) the SBS does not need to send control commands to the MS to scan for and associate with TBSs and (2) the MS does not need to send associated reports to the SBS. Performing PHY level detection on multiple TBSs help in decoding broadcast control and data information from candidate TBSs.

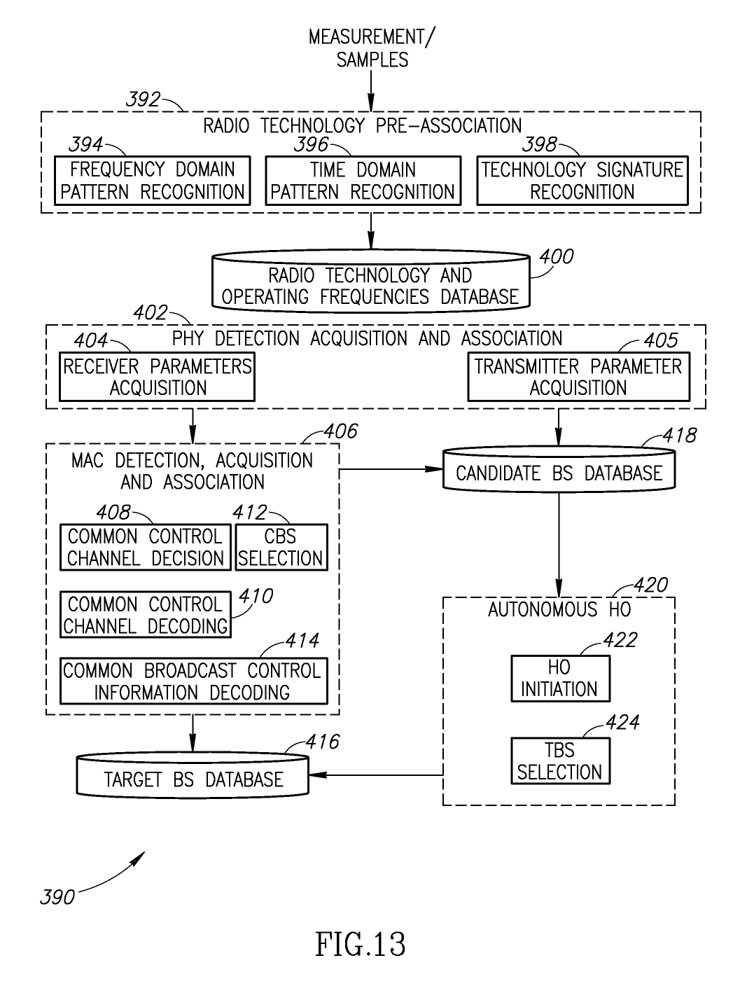

A diagram illustrating the candidate base station selection and handover initiation process is shown in FIG. 13. This process depends on the parameter measurements and samples obtained using the discovery, detection, decoding and association method of FIGS. 12A and 12B. The process, generally referenced 390, comprises a RAT pre-association block into which the measurements/samples are input. The RAT pre-association block comprises frequency domain pattern recognition block 394, time domain patter recognition block 396 and technology signature recognition block 398. The results of the recognition functions are stored in a RAT and operating frequencies database 400.

The data stored in the RAT and operating frequencies database 400 are used by the PHY detection block 402 to acquire one or more receiver and transmitter parameters via receiver parameter acquisition block 404 and transmitter parameter acquisition block 405, respectively. These parameters are stored in the candidate BS data base 418 and input to the MAC detection block 406.

The MAC detection, acquisition and association block 406 uses the receiver and transmitter parameters acquired in generating common control channel decisions (block 408), selecting one or more candidate base stations (CBSs) (block 412), performing common control channel decoding (block 410) and common broadcast control information decoding (block 414). The results of the MAC detection block 406 are stored in a target base station database 416 and the candidate base station database 418.

An autonomous handover block 420 functions to perform handover initiation (block 422) and selection of the TBS from amongst the candidate base stations (block 424). The results from the autonomous handover block processing are stored in the target base station database 416.

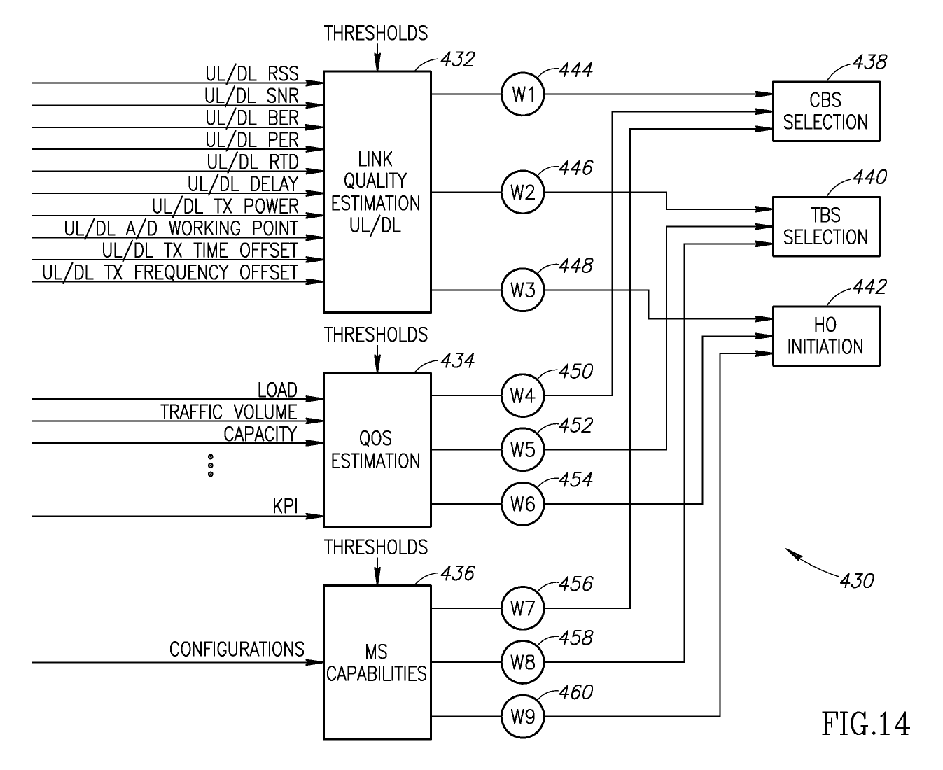

A diagram illustrating and example mechanism for TBS and CBS selection and handover initiation is shown in FIG. 14. This block diagram shows an example process, generally referenced 430, of selecting the candidate base station, target base station and performing HO initiation all of which utilize output from a link quality estimation block 432, QoS estimation block 434 and MS capabilities block 436 in their determination processes.

The link quality estimation block 432 takes as input a plurality of UL and DL link quality related parameters such as RSS, SNR, PER, RTD, Delay, TX power, A/D working point, TX time offset, TX frequency offset, etc. as described supra. Based on one or more input thresholds, the block outputs estimates of the link quality between the MS and one or more base stations. Each of the link quality estimates is weighted via weights W1 444, W2 446, W3 448 before being input to each of the selection and initiation blocks 438, 440, 442, respectively.

The QoS estimation block 434 takes as input a plurality of UL and DL QoS related parameters such as Load, traffic volume, capabilities, KPI, etc. as described supra. Based on or more input thresholds, the block outputs QoS estimates of the link between the MS and one or more base stations. Each of the QoS estimates is weighted via weights W4 450, W5 452, W6 454 before being input to each of the selection and initiation blocks 438, 440, 442, respectively.

The MS capabilities block 436 takes as input a plurality of configuration information. Based on or more input thresholds, the block outputs capability information wherein each of the MS capability estimates is weighted via weights W7 456, W8 458, W9 460 before being input to each of the selection and initiation blocks 438, 440, 442, respectively.

### Multi-Cell Connectivity and Association: WiMAX Example

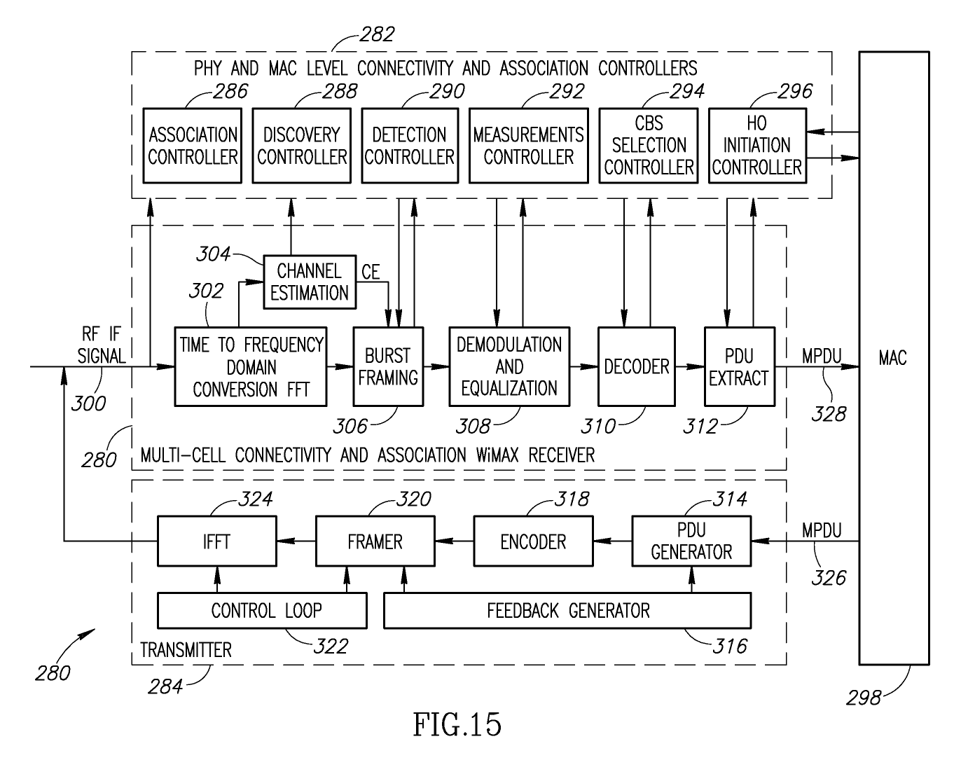

An example of the multi-cell association mechanism of the present invention adapted for use with the IEEE 802.16 WiMAX standard will now be presented. A block diagram illustrating an example multi-cell connectivity and association WiMAX transceiver constructed in accordance with the present invention is shown in FIG. 15. Note that for clarity sake, only the relevant portions of the transceiver are shown. The multi-cell connectivity and association WiMAX transceiver, generally referenced 280, comprises a receiver 281, transmitter 284 and PHY and MAC level connectivity and association controllers block 282.

The receiver 281 comprises a time to frequency domain conversion block 302 adapted to receive an RF intermediate frequency (IF) signal 300, channel estimation 304, burst framing block 306, demodulation and equalization block 308, decoder 310 and PDU extract block 312 operative to output MAC PDUs (MPDUs) 328 to MAC 298.

In accordance with the invention, the transceiver also comprises PHY and MAC level connectivity and association controllers 282 comprising an association controller 286, discovery controller 288, detection controller 290, measurements controller 292, CBS selection controller 294 and HO initiation controller 296 which are in communication with the receiver 281 elements and the MAC 298. The PHY and MAC level connectivity and association controller performs the mechanisms of the present invention as described in detail supra.

The transmitter 284 comprises PDU generator 314 operative to receive MAC PDUs 326 from the MAC 298, encoder 318, framer 320, IFFT 324, feedback generator 316 and control loop 322.

In operation, in the receive direction, a sampled discrete baseband RF signal (300) composed of both the SBS and TBS(s) is received from the RF front end (not shown) and input to the time to frequency domain converter (FFT) (302) where it is converted to a frequency discrete signal. The frequency discrete signal is input to the channel estimation block (304) which functions to perform channel estimation for each source, based on the preamble series and pilots PRBS from each source (i.e. SBS or TBS). The channel estimation (CE) is input to the burst framing block (306) which functions to perform the transition from the frequency domain to the logical channel domain which, together with the CE results, converts the received signal from a composed form to a separate signal for the SBS and each TBS. These signals are then demodulated (block 308), decoded (block 310) and the PDUs extracted (block 312). The MAC PDUs are sent to the MAC 298 for MAC level processing.

In the transmit direction, PDUs are generated from input MAC PDUs by PDU generator 314 and encoded (block 318). The encoded stream is converted to frames by the framer 320 and undergoes IFFT 324 to generate the output IF signal 300.

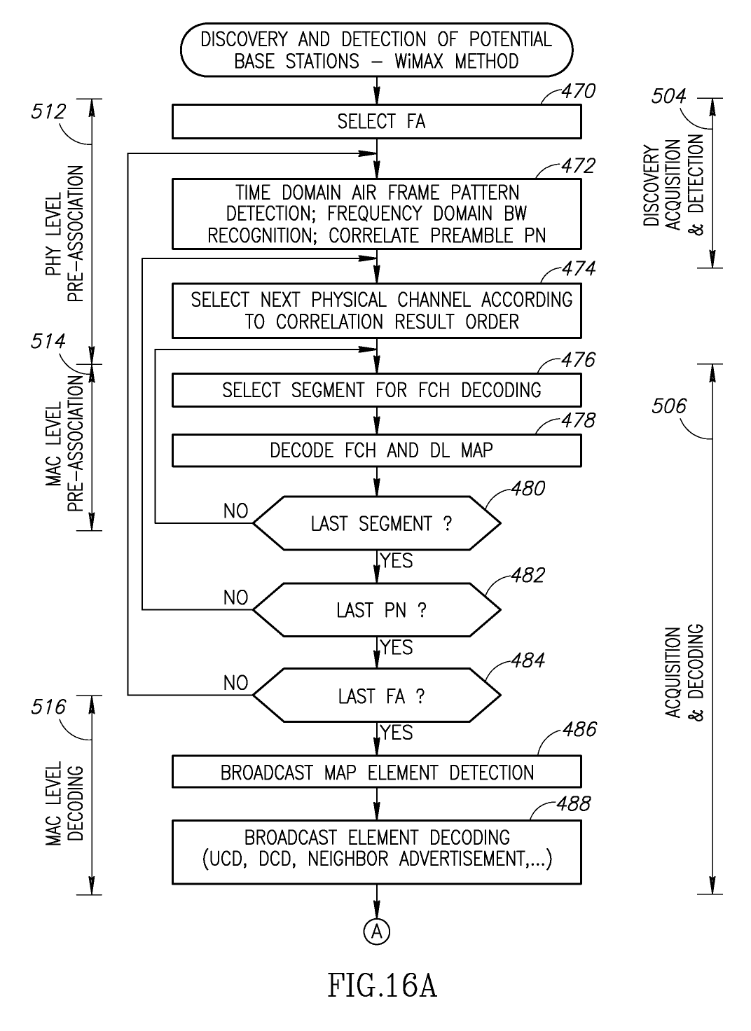

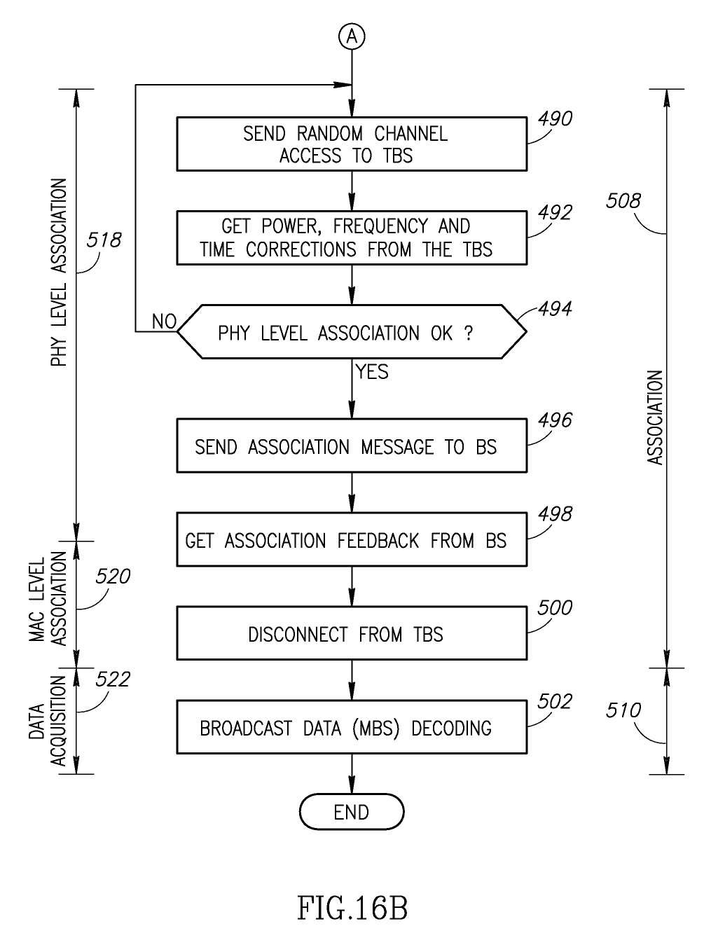

A flow diagram illustrating a multilevel method for the discovery, detection and decoding of candidate base stations for WiMAX networks is shown in FIGS. 16A and 16B. The method is divided into a plurality of stages or phases including discovery, acquisition and detection 504, acquisition and decoding 506, association 508, information decoding 510, PHY level pre-association 512, MAC level pre-association 514, MAC level decoding 516, PHY level association 518, MAC level association 520 and data acquisition 522.

First, the frequency allocation (FA) is selected (step 470). The frequency allocation is selected based on the current operating frequency and the particular capability of the MS radio. Next, time domain air frame patter detection, frequency domain bandwidth recognition and preamble PN correlation are performed (step 472). Note that in this step, all 114 possible preamble pseudo noise (PN) sequences are correlated and ordered in accordance with the correlation results. The next physical channel to scan is selected in accordance with the ordering of the correlation results (step 474). A segment is then selected for decoding of its frame control header (FCH) (step 476). The FCH and downlink medium access protocol (DL-MAP) fields are decoded (step 478). The above steps are repeated in three nested loops for each segment (step 480), PN sequence (step 482) and foreign agent (step 484).

Immediately after the downlink preamble, each downlink frame comprises a Frame Control Header (FCH) which is sent at the lowest modulation and coding rate to ensure all subscriber stations in the coverage cell can receive it. The FCH is used to identify the BS and to describe one or more separate broadcast bursts of payload data in the downlink frame. Examples of data that may be in the first broadcast burst; includes, maps, burst profile descriptions (UCD, DCD), grant allocations for initial ranging, grant allocations for contention bandwidth requests, etc.

The DL-MAP field provides information on the DL burst allocation and PHY layer control and management messages (e.g., information elements or IEs). It is inserted in the first broadcast burst following the FCH field to describe other bursts that follow the FCH broadcast burst.

Once a candidate target base stations has been found and the FCH and DL-MAP fields have been decoded, the broadcast MAP elements are detected (step 486). This includes detecting the capabilities and broadcast parameters of the target base station. Once detected, the broadcast elements are then decoded (step 488). Example broadcast elements include, for example, Downlink Channel Descriptor (DCD) messages and Uplink Channel Descriptor (UCD) messages. The base station inserts a Downlink Channel Descriptor (DCD) and/or an Uplink Channel Descriptor (UCD) message after any downlink and uplink maps in the first broadcast burst. The purpose of the DCD/UCD is to define downlink/uplink burst profiles specifying parameters such as modulation type, FEC, scrambler seed, cyclic prefix, and transmit diversity type. Once defined, burst profiles are referred to in later downlink maps via a numerical index called the Downlink Interval Usage Code (DIUC) or Uplink Interval Usage Code (UIUC), which is associated with the profile.

In the PHY level association stage 518, the MS sends random channel access to the TBS (step 490). In this step, bidirectional communications is established between the MS and TBS. Preliminary information such as that required for handover (e.g., power, frequency and time offsets) is then exchanged (step 492). If the current operation point of the PHY level association not acceptable (step 494), the channel is adjusted and the method returns to step 490. Otherwise, association messages are sent to the TBS (step 496). The messages may comprise requests or queries of the TBS for information, e.g., capabilities, services offered, etc. Once associated feedback is received from the TBS (step 498), the MS disconnects from the TBS (step 500).

Note that typically, MAC level association with a TBS is performed only once. Further, based on the information feedback from the TBS, the MS may decode to associate with another BS or select another BS to be the next SBS. PHY level association, however, may be conducted several times based on MS decision and channel tracing capabilities.

Broadcast data (e.g., MBS) is then decoded (step 502), e.g., mobile neighbor advertisement (NBR-ADV) messages. Mobile neighbor advertisement messages provide information into the available neighboring base stations for use in considering cell selection.

Additional parameters and information are obtained by decoding other messages on the broadcast connection ID (CID). The 16-bit connection ID (CID) field defines the connection that the particular packet is servicing. Each connection is identified a unique CID. Since connections are unidirectional, two CIDs are used in a bidirectional link.

### Multi-Cell Connectivity and Association: GSM Example

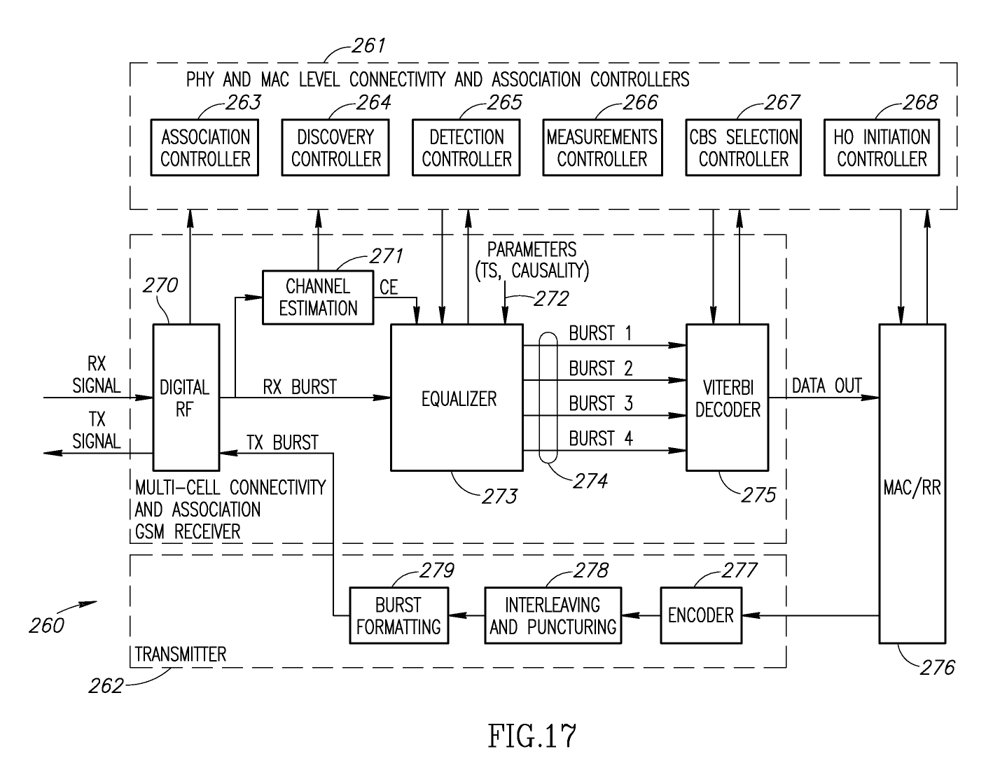

An example of the multi-cell connectivity and association mechanism of the present invention adapted for use with the GSM standard will now be presented. A block diagram illustrating an example multi-cell connectivity and association GSM transceiver constructed in accordance with the present invention is shown in FIG. 17. Note that for clarity sake, only the relevant portions of transceiver are shown. The multi-cell connectivity and association GSM transceiver, generally referenced 260, comprises a receiver 269, transmitter 262 and PHY/MAC level connectivity and association controller block 261 and digital RF block 270. The digital RF block is used by the transmitter to transmit a TX signal and the receiver to receive an RX signal.

The receiver 269 comprises channel estimation block 271, equalizer 273 and Viterbi decoder 275 operative to output the receive data to the MAC 276. In accordance with the invention, the transceiver 260 also comprises PHY and MAC level autonomous connectivity and association controllers 261 comprising an association controller 263, discovery controller 264, detection controller 265, measurements controller 266, CBS selection controller 267 and HO initiation controller 268 which are in communication with the receiver 269 and transmitter 260 elements and MAC 276. The PHY and MAC level autonomous connectivity and association controller performs the mechanisms of the present invention as described in detail supra. The transmitter 262 comprises encoder 277, interleaver and puncturing 278 and burst formatting block 279 which outputs the TX burst for transmission.

In operation, a receive RF signal is received by the digital RF block 270. The receive RF signal comprises both the SBS and TBS(s) transmitted signals. The digital RF block 270 functions to converts the analog RF signal to discrete signals i.e. samples. The discrete signal passes to the channel estimator (block 271) which, based on their respective Training Sequence (TS), performs a channel estimation for the SBS and the TBS(s). The discrete signal and CE are input to equalizer 273 and using the SBS TS parameters 272 and channel estimates (CEs), the equalizer functions to remove the TBS signal perceived by the receiver as an interferer. This operation is similarly performed by the equalizer over the combined signal using the TBS channel estimate and TBS TS 272. After reception of four bursts 274 for either SBS or TBS(s) the four bursts are input to the Viterbi decoder 275 which performs the channel decoding operation (i.e. forward error correction or FEC decoder), interleaving and de-puncturing operations. Once these operations are complete, the resulting data block is transferred to the MAC 276 for MAC level processing.

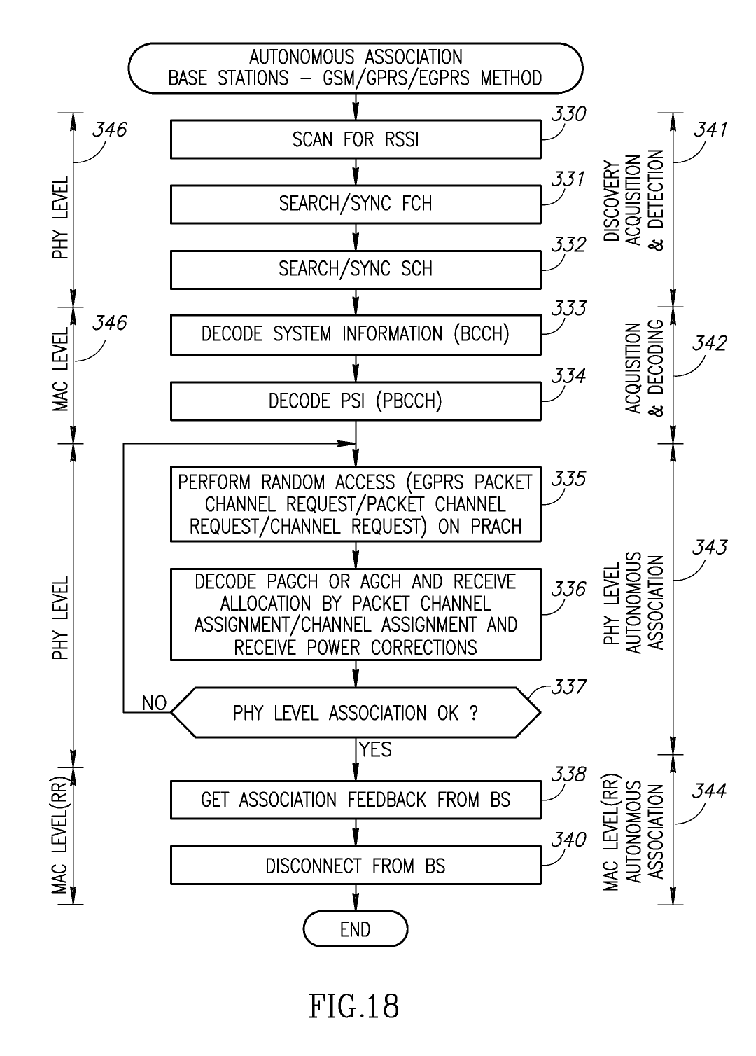

A flow diagram illustrating a multilevel discovery, detection, decoding and association method of candidate base stations for GSM networks is shown in FIG. 18. The method is divided into a plurality of states or phases including discovery, acquisition and detection 341, acquisition and decoding 342, PHY level pre-association 345, MAC level pre-association 346, association 347, PHY level autonomous association 343 and MAC level autonomous association 344. To find neighbor base stations, the receiver first scans GSM channels measuring receive signal strength indication (RSSI) values at each channel (step 330). The acceptable channels each represent a target base station and as a group comprise the scan set of CTBSs. For those channels in the Once the channels are identified, a search is made for the frequency correction burst (FCH) transmitted by the base station (step 331). A search is also made for the synchronization burst (SCH) transmitted by the base station (step 332).

Wireless communication systems such as GSM use a combination of Frequency Division Multiple Access (FDMA) and Time Division Multiple Access (TDMA) to provide access to multiple users. In FDMA/TDMA-based systems, frequency and timing synchronization between the receiver and transmitter is required before communications can occur. The GSM standard provides a frequency correction burst (FCH burst) for frequency synchronization, and a synchronization burst (SCH burst) for timing synchronization in the Broadcast Control Channel (BCCH) carrier. The FCH burst is required to achieve frequency synchronization. Typical FCH detection methods exploit the narrow-band nature of the FCH burst. One method uses a bandpass filter of constant bandwidth, centered at the expected frequency of the FCH burst. Another uses the correlation between the received signal and a reference signal selected depending on the expected frequency of the FCH burst.

Once the FCH and SCH bursts are used to achieve synchronization and timing, system information as conveyed in the BCCH message can be decoded (step 333). Each base station transmits information about its cell on a broadcast control channel of its own, to which all mobile stations in the area of the cell listen. The BCCH of a base station continuously sends out identifying information about its cell site, such as its network identity, the area code for the current location, whether frequency hopping and information on surrounding cells. The BCCH downlink channel contains specific parameters needed by a mobile station identify the network and gain access to it. Typical information in the BCCH comprises the Location Area Code (LAC), the Routing Area Code (RAC), the Mobile Network Code (MNC) and the BCCH Allocation (BA) list. Once homed in on the Broadcast Control Channel the mobile station monitors the data stream transmitted by the base station looking for a frequency control channel burst (FCCB). The mobile uses the Frequency Correction Channel (FCCH) to synchronize itself with the GSM framing.

With reference to GPRS systems, once the BCCH system information is decoded, packet system information (PSI) is then decoded on the packet switched broadcast control channel (PBCCH) if it exists (step 334). If a mobile station is in packet transfer mode, packet system information (PSI) messages are transmitted on the PBCCH channel from the network to the mobile station. Using the PSI messages decoded from the PBCCH channel, the mobile station can determine whether a packet data link can be set up in the cell and also what parameters it needs to set up and operate the connection in the cell. Once these messages are found and decoded for a target base station, the mobile station can establish a DL connection.

Once the DL is established, the MS performs random access (EGPRS Packet Channel Request/Packet Channel Request/Channel Request) on the PRACH (step 335). The MS then decodes the PAGCH or AGCH and receives an allocation by Packet Channel Assignment/channel assignment and receive power corrections (step 336). The MS may also receive any other preliminary information required for the handover procedure. If the operation point of the PHY level association is not acceptable (step 337), the method returns to repeat step 335. Otherwise, the MS then receives association feedback from the base station (step 338). This comprises any number of link layer parameters the MS may or may not use to determine the CBS. Once the association is complete, the MS disconnects from the base station (step 340).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for use on a mobile station connected to a network, said method comprising the steps of:
selecting a set of one or more candidate target base stations;
attempting connecting to said set of one or more candidate target base stations over the same or across a plurality of access technologies;
performing autonomous association of one or more candidate target base stations, wherein said autonomous association is performed anonymously while maintaining connectivity to a serving base station; and
updating said selection based on information exchanged during said autonomous association.

2. The method according to claim 1, wherein said autonomous association comprises establishing a bidirectional link between said mobile station and said one or more candidate target base stations to obtain preliminary parameters required for handover with a base station.

3. The method according to claim 1, wherein said autonomous association with one or more candidate base stations is performed without assistance or any negotiation with the network.

4. The method according to claim 1, further comprising the step of completing a handover process with one or said candidate base stations utilizing information obtained during said autonomous association.

5. The method according to claim 1, further comprising the step of assisting a network initiated handover decision by providing a candidate target base station database thereto.

6. The method according to claim 1, wherein said candidate base stations are selected based on said information exchanged between said mobile station and said one or more candidate base stations including one or more physical and/or media access control (MAC) layer elements.

7. The method according to claim 6, wherein said one or more elements comprises link level, link quality and received signal quality measurements.

8. The method according to claim 6, wherein said one or more elements comprises end-to-end quality of service.

9. The method according to claim 6, wherein said one or more elements comprises any parameters able to be measured without assistance from a target base station.

10. The method according to claim 6, wherein said one or more elements comprises any parameters that can potentially effect the handover process.

11. The method according to claim 1, wherein association opportunities are created autonomously in accordance with instantaneous activity patterns of target base stations in said network.

12. A method for use on a mobile station connected to a network, said method comprising the steps of:
selecting a set of one or more candidate target base stations;
attempting connecting to said set of one or more candidate target base stations over the same or across a plurality of access technologies;
performing autonomous association of one or more candidate target base stations; and
initiating a handover procedure to a specific candidate target base station in accordance with information exchanged during said autonomous association.

13. The method according to claim 12, wherein said autonomous signaling discovery and detection is performed without any negotiation with the network.

14. The method according to claim 12, wherein said step of initiating comprises the step of requesting a handover from said network to said specific candidate target base station.

15. The method according to claim 12, wherein said autonomous association comprises performing ranging over an uplink channel to obtain timing, power and frequency synchronization prior to handover with a base station.

16. A method of autonomous association between a mobile station and a plurality of target base stations in a network, said method comprising the steps of:
detecting potential target base stations in said network to generate a candidate target base station list;
performing signal discovery and detection measurements on said candidate target base stations over the same or across a plurality of access technologies;
autonomously performing ranging over an uplink channel to one or more candidate base stations to exchange information and perform timing, power and frequency synchronization prior to handover with a base station;
updating said candidate target base station list in accordance with information exchanged during said step of ranging.

17. The method according to claim 16, wherein said autonomous ranging is performed anonymously and without any negotiation with the network.

18. The method according to claim 16, wherein said information exchanged comprises one or more parameters that affect the handover process that can be measured or obtained from a candidate target base station without assistance thereby.

19. An apparatus for performing association between a mobile station and a plurality of target base stations in a network, comprising:
a modem operative to receive and transmit radio frequency (RF) signals over said network, said modem comprising a cellular connectivity decoder;
a memory for storing candidate target base stations and parameter information associated therewith;
a processor coupled to said modem, said processor operative to:
detect potential target base stations in said network to generate a candidate target base station list;
perform signal detection and measurements on said candidate target base stations over the same or across a plurality of access technologies;
autonomously perform ranging over an uplink channel to one or more candidate base stations to obtain timing, power and frequency synchronization prior to handover with a base station; and
update said candidate target base station list with information exchanged during said step of ranging.

20. The apparatus according to claim 19, wherein said autonomous ranging is performed without any negotiation with the network.

21. The apparatus according to claim 19, wherein said information exchanged comprises one or more parameters that affect the handover process that can be measured or obtained from a candidate target base station without assistance thereby.

22. The apparatus according to claim 19, wherein said processor is further operative to perform a handover from a serving base station to a selected target base station utilizing said information exchanged, thereby minimizing switching time to said selected target base station.

23. A mobile station, comprising:
a radio transceiver and associated media access control (MAC) operative to receive and transmit signals over a radio access network (RAN) to a serving base station and to receive signals over said RAN from one or more target base stations;
a connectivity unit coupled to said radio transceiver for maintaining connectivity to a plurality of target base stations in a network;
an autonomous association unit, said autonomous association unit operative to:
select a set of one or more candidate target base stations;
perform signaling discovery and detection on said set of one or more candidate target base stations over the same or across a plurality of access technologies;
perform autonomous ranging to one or more candidate base stations over respective uplink channels to exchange information and perform timing, power and frequency synchronization prior to handover with a base station;
update said selection based on information exchanged via said autonomous ranging; and
a processor operative to send and receive data to and from said radio transceiver, said connectivity unit and said autonomous association unit.

24. The mobile station according to claim 23, wherein associations between said selected group of candidate target base stations and said mobile station are maintained anonymously and autonomously such that a serving base station is unaware of said associations.

25. The mobile station according to claim 23, wherein said autonomous association unit is operative to exchange information in parallel with a serving base station over respective uplink channels connecting said mobile station to one or more candidate target base stations.

26. The mobile station according to claim 23, furthering comprising means for requesting a handover from said network to a selected candidate target base station based on said information exchanged and said timing, power and frequency synchronization.
